(19) United States
(12) Patent Application Publication
(10) Pub. No.: US 2011/0213077 A1
(43) Pub. Date: Sep. 1, 2011

(54) Hydroquinone-containing polyesters having improved whiteness

(75) Inventors: Maria G. Bertucci, Cumming, GA (US); Nancy J. Singletary, Alpharetta, GA (US); Jan G. Nel, Appling, GA (US); Christie W. Crowe, Alpharetta, GA (US); Geert J. Verfaillie, Parike (BE); Glenn W. Cupta, Roswell, GA (US)

(73) Assignee: SOLVAY ADVANCED POLYMERS, L.L.C., Alpharetta, GA (US)

(21) Appl. No.: 13/126,509

(22) PCT Filed: Oct. 30, 2009
(86) PCT No.: PCT/EP2009/064393

§ 371 Date: Apr. 28, 2011

Related U.S. Application Data
(60) Provisional application No. 61/109,537, filed on Oct. 30, 2008.
(60) Provisional application No. 61/140,647, filed on Dec. 24, 2008.

(51) Int. Cl. C08L 67/02; C08G 63/183

(52) U.S. Cl. 524/605; 528/193

(57) ABSTRACT

A polyester containing polymerized units of hydroquinone; 4,4′-biphenol; and hydroxybenzoic acid; terephthalic acid and optionally isophthalic acid. A method of forming a polyester including first acylating a mixture of hydroquinone; 4,4′-biphenol; terephthalic acid and optionally isophthalic acid; and hydroxybenzoic acid; and then polycondensing the resulting acylated mixture. The polyester is suitable for uses such as lighting where high whiteness, high reflectivity and high heat resistance are desirable.

### CROSS REFERENCE TO RELATED APPLICATIONS

The present application claims the priority benefit to U.S. provisional application No. 61/106,177 filed on Oct. 30, 2008, and to U.S. provisional application No. 61/140,647 filed on Dec. 24, 2008, the whole content of these applications being herein incorporated by reference for all purposes.

### FIELD OF THE INVENTION

The invention relates to a polyester containing polymerized hydroquinone units, polymerized diol units, polymerized hydroxycarboxylic acid units, and polymerized dicarboxylic acid units. Compositions that contain the polyester are included in the invention as well as articles made from compositions that include the polyester such as injection molded parts. The polyester of the invention has improved whiteness, hue and physical properties. The invention includes a method for making the polyester of the invention by acylating a mixture of monomer units and subsequently heating the acylated product.

### BACKGROUND OF THE INVENTION

Polyester polymers are well known in the polymer art. Polyesters are typically made by condensing dicarboxylic acid monomer compounds with diol monomer compounds. The resulting condensed polymeric product has alternating and repeating structural units derived from the carboxylic acid-containing monomers and the diol-containing monomers. Common polyester resins include resins having polymerized dicarboxylic acid monomer units derived from, for example, isophthalic acid and/or terephthalic acid.

When the carboxylic acid monomer unit and/or the diol monomer unit of a polyester includes an aromatic group, such as in a polyester containing polymerized units of isophthalic acid and biphenol, the resulting polyester is referred to as an “aromatic polyester.” Aromatic polyesters may contain, in addition to aromatic group-containing monomer units, other monomer units that are free of aromatic groups. For example, a polyester polymer may be made from an aromatic dicarboxylic acid monomer compound and an aliphatic diol monomer compound such that the resulting polyester material contains alternating aromatic and non-aromatic structural units.

Aromatic compound denotes a compound comprising at least one arylene group. An arylene group is usually a hydrocarbon divalent group consisting of one core composed of one benzenic ring or of a plurality of benzenic rings fused together by sharing two or more neighboring ring carbon atoms, and of two ends.

Non limitative examples or arylene groups are phenylenes, naphthylenes, anthrylenes, phenanthrylenes, tetracenylenes, triphenylylenes, pyrenylenes, and perylenylenes. The arylene groups (especially the numbering of the ring carbon atoms) were named in accordance with the recommendations of the CRC Handbook of Chemistry and Physics, 64th edition, pages C1-C44, especially p. C11-C12.

Arylene groups present usually a certain level of aromaticity; for this reason, they are often reported as “aromatic” groups. The level of aromaticity of the arylene groups depends on the nature of the arylene group; as thoroughly explained in Chem. Rev. 2003, 103, 3449-3605, “Aromaticity of Polycyclic Conjugated Hydrocarbons”, the level of aromaticity of a polycyclic aromatic hydrocarbon can be notably quantified by the “index of benzene character” B, as defined on p. 3531 of the same paper; values of B for a large set of polycyclic aromatic hydrocarbon are reported on table 40, same page.

An end of an arylene group is a free electron of a carbon atom contained in a (or the) benzenic ring of the arylene group, wherein an hydrogen atom linked to said carbon atom has been removed. Each end of an arylene group is capable of forming a linkage with another chemical group.

A polyester that includes only aromatic structural units is known as a “wholly aromatic” polyester. Wholly aromatic polyesters include only structural units that have one or more aromatic groups. The structural units of a wholly aromatic polyester are bonded to bridging groups that connect first and second structural units that are different. Bridging groups such as acyl groups that connect different aromatic structural units are not considered to interrupt the wholly aromatic characteristics of a wholly aromatic polyester. Aromatic group-containing structural units that contain more than one aromatic group connected by an aliphatic group in a polyester polymer are excluded from wholly aromatic polyesters. For example, polymers containing polymerized units of the diol monomer compound bis-phenol A are not wholly aromatic polymers.

Liquid crystalline polyesters (LCPs) are generally divided into two groups depending upon whether they exhibit liquid crystalline or anisotropic order in solution (lyotropic) or in the melt phase (thermotropic). Thermotropic LCPs have been described by such terms as “liquid crystalline,” “liquid crystal” or “anisotropic”. Thermotropic LCPs include, but are not limited to, wholly aromatic polyesters, aromatic-aliphatic polyesters, aromatic polyazomethines, aromatic polyester-carbonates and partly or wholly aromatic polyester-amides. Typically, LCPs are prepared from rigid rod molecules that are fairly rigid along their molecular axes. These polymers also tend to have coaxial or parallel chain-extending linkages therebetween.

A liquid crystalline polyester orients the molecular chain in the direction of flow under low shear stress. Liquid crystalline polyesters have excellent melt flowability and generally have a heat resistant deformation property of 150° C. or higher depending on their structure.

LCPs are generally inflammable and radiation resistant. They generate very little smoke and do not drip when exposed to live flame. LCPs can serve as an excellent electrical insulator with high dielectric strength and outstanding arc resistance. LCPs resist chemical attack from most polar and nonpolar solvents, including but not limited to: hot water, acetic acid, other acids, methyl ethyl ketone, isopropyl alcohol, trichloroethylene, caustics, bleaches and detergents, and hydrocarbons. LCPs generally have very low coefficients of friction and retain substantially high strength levels at relatively high temperatures. Aromatic polyesters have been known in the art for many years.

U.S. Pat. No. 4,414,365, incorporated herein by reference in its entirety, discloses a process for producing aromatic polyester compositions. The patent discloses polymers that include one or more aliphatic and/or heteroatom groups separating the aromatic groups of a single monomer unit or different monomer units. Polymerization includes reacting carboxylic acid-containing monomer compounds with diol monomer compounds in the presence of an anhydride to form a polymerizate, and then subsequently heating the polymerizate at elevated temperatures to form a polymer by solid state polycondensation.

U.S. Pat. No. 4,751,128, incorporated herein by reference in its entirety, discloses fully aromatic thermotropic liquid crystalline polyesters. The fully aromatic thermotropic liquid crystalline polyesters include monomer units derived from hydroxybenzoic acid, terephthalic acid, isophthalic acid, hydroquinone, biphenol and optional amounts of other dihydroxy compounds. The hydroquinone and the biphenol may be present in a molar ratio of 0.1:1 to 2.67:1, isophthalic acid and terephthalic acid may be present in a molar ratio of 1:19 to 1:1.04. Processes for making the fully aromatic thermotropic polyester include single-stage melt polycondensation and a two-step process with acylation in a pre-polymerization step followed by a solid state condensation. No compositions having a molar ratio of isophthalic acid to terephthalic acid of 1:20 or less are disclosed. Improved heat distortion temperatures of 250° C. (ISO R75Method B 1.80N/mm²) along with resin melting points of less than 350° C. are described.

U.S. Pat. No. 5,037,939, incorporated herein by reference in its entirety, discloses thermotropic, fully aromatic polyesters with improved toughness (≧50 kJ/m2, Izod method 1C), high HDT (≧260° C., ISO/R75, method A) and good processability (<380° C.; examples at 240 to 350° C.). The polyesters may include polymerized monomer units derived from hydroxybenzoic acid, hydroquinone, biphenyl, terephthalic acid and/or isophthalic acid. Compositions with polymerized isophthalic and terephthalic acid monomers in molar ratios of 0.24:1 to 0.68:1 are disclosed with improved impact heat properties and heat distortion temperatures. Compositions with heat distortion temperatures up to 275° C. are described.

WO 90/03992, incorporated herein by reference in its entirety, describes the use of hydroxybenzoic acid, terephthalic acid, isophthalic acid, hydroquinone and biphenol in well specified proportions to yield polymers having certain mechanical and thermal properties. The compositions are in part defined by the ratio of moles of hydroquinone to moles of biphenol, which is in the range of 3:1 to 21:1.

U.S. Pat. No. 5,529,716, incorporated herein by reference in its entirety, discloses liquid crystalline polyester resins that include filler materials such as aluminum powder and, optionally, inorganic materials such as titanium dioxide.

U.S. 2004/0165390, incorporated herein by reference in its entirety, discloses the use of liquid crystalline polyester resins for making injection molded articles. The liquid crystalline polyester materials include wholly aromatic polyesters that preferably have a yellowness index (YI) of 32 or less.

U.S. 2006/0084747, incorporated herein by reference in its entirety, discloses a method for manufacturing wholly aromatic liquid crystalline polyester resins. The method includes acylating a mixture of monomer units and subsequently subjecting the acylated mixture to a polycondensation reaction in the presence of a metal dihydrogen phosphate. No compositions comprising monomer units derived from solely from combinations of hydroxybenzoic acid, terephthalic acid, isophthalic acid, hydroquinone and biphenol are disclosed. Whiteness values (W) determined from L*, a* and b* values in the range of 79.0-88.9, are described in the examples.

U.S. 2007/0243376, incorporated herein by reference in its entirety, discloses a resin LCP and a method for making the LCP that includes subjecting a mixture of carboxylic acid-containing monomer units and diol monomer units to acylation followed by solid state condensation. The resin is reported to generate amounts of acetic acid gas of about 200 ppm after heating at a temperature that is 10° C. greater than the melting point of the liquid crystal resin. The monomer units of the liquid crystal resin include compounds such as hydroxybenzoic acid, biphenol, hydroquinone, terephthalic acid and isophthalic acid. Compositions with the property of reduced acetic acid, phenol and carbon dioxide emissions are defined in part by controlling the content of terephthalic acid to 60 to 92% of the total moles of terephthalic and isophthalic acid.

Published Japanese Patent Application No. JP 2007-169379, incorporated herein by reference in its entirety, discloses thermoplastic compositions including liquid crystalline polyesters, which are described as having improved moldability. The polyester resins include polymerized units of hydroxybenzoic acid, diphenol, hydroquinone, isophthalic acid and terephthalic acid. The compositions are in part defined by controlling the content of terephthalic acid to 75 to 80% of the total moles of terephthalic and isophthalic acid.

Published Japanese Patent Application No. JP 2008-063498, incorporated herein by reference in its entirety, discloses liquid crystalline polyester compositions. The liquid crystal polyester resin is present as a mixture with one or more other materials and is described to be useful for making thin-walled articles. The polyester resin compositions contain monomer units such as hydroxybenzoic acid, diphenol, hydroquinone, isophthalic acid and terephthalic acid.

Published Japanese Patent Application No. JP 2004-277539, incorporated herein by reference in its entirety, discloses liquid crystalline polyesters that may contain aromatic monomer units and include 30% of more units of hydroxybenzoic acid. Compositions containing the liquid crystalline polyesters are disclosed to be useful in LED objects. The liquid crystalline polyesters may contain monomer units such as 4-hydroxyisophthalic acid, salicylic acid, 3-hydroxy-2-naphthoic acid, 6-hydroxy-2-naphthoic acid, 2-hydroxynaphthalene-3,6-dicarboxylic acid, p-hydroxybenzoic acid, hydroquinone, and terephthalic acid.

Published Japanese Patent Application No. JP 2007-320996, incorporated herein by reference in its entirety, discloses liquid crystalline polyesters that may contain p-hydroxybenzoic acid, hydroquinone, biphenol, isophthalic acid, and terephthalic acid. Compositions containing the liquid crystalline polyesters in combination with one or more blue coloring agents to reduce yellowing are also described.

Published Japanese Patent Application No. JP 2007-326925, incorporated herein by reference in its entirety, discloses liquid crystalline polyesters that may contain p-hydroxybenzoic acid, hydroquinone, biphenol, isophthalic acid, and terephthalic acid. The liquid crystalline polyesters have a relatively high ratio amount of isophthalic acid. The liquid crystalline polyester may be used as a mixture with titanium oxide to make reflectors.

LCPs such as one or more of those mentioned above are conventionally used in applications requiring high heat resistance. For example, LCPs can be used to make cookware. Conventional LCPs are formulated from certain monomer mixtures for this purpose and typically contain both isophthalic acid and terephthalic acid monomer units in a molar ratio of significantly greater than 0.1. Certain physical properties such as high melting point, high elongation and high melt viscosity make such conventional LCPs difficult to process.

Commercially available LCPs such as XYDAR™ SRT-300, available from Solvay Advanced Polymers, LLC, have high heat deflection temperature but are relatively highly colored, e.g., have high yellowness index, and/or have flow properties that complicate their use in certain applications, i.e., LED and small connectors. Other commercially available LCPs such as XYDAR™ SRT-1000, also available from Solvay Advanced Polymers, LLC, have improved color properties, e.g., good whiteness as measured by ΔE, but have lower heat distortion temperatures (<260° C.).

New applications such as reflectors for light emitting diodes (LEDs), including but not limited to power LEDs, require a combination of excellent color and improved physical properties such as high heat distortion temperature, high elongation, and/or easy processing due to melt viscosity matched to processing conditions/equipment part configuration. Conventional LCPs are unable to provide a combination of these attributes in a single resin.

### SUMMARY OF THE INVENTION

While polyesters and liquid crystalline polyesters (LCP) having one or more aromatic carboxylic acid-containing groups and one or more aromatic diol-containing groups are known there exists a need for polyesters that exhibit exceptional whiteness, superior heat resistance and have superior physical properties. The whiteness properties of the polyesters discussed above are not suitable for certain lighting applications especially LED-based lighting and applications in which whiteness is an important property for light reflection. The polyesters of the invention combine exceptional whiteness properties with superior heat resistance and improved physical properties.

As explained in detail below, the inventors have discovered that polyesters made from mixtures containing aromatic group-containing monomer compounds in certain mole ratios exhibit surprising whiteness and physical properties. The use of polyesters for applications such as high intensity lighting applications where a superior balance of color, dimensional stability at high temperature, good ductility, high heat deflection (HDT), solder resistance and excellent flow properties (e.g., nematic LCP) is now feasible.

Although polyesters made from similar mixtures of the monomer compounds described herein are known, the polyesters of the invention are newly described herein and, surprisingly, were shown by the inventors to exhibit substantially improved properties not observed in polyesters of different composition.

One aspect of the invention is a polyester having superior mechanical properties such as high temperature performance, low color and processing capability at moderate temperatures.

Another aspect of the invention is the use of the polyester as a component of a light emitting diode (LED) device, including but not limited to a power LED.

Another aspect of the invention is the use of the polyester to make molded parts such as connectors and bobbins.

Another aspect of the invention is the use of the polyester to make fibers and films.

### DESCRIPTION OF THE DRAWINGS

FIG. 1 shows reflectance properties of molded parts made from polyester compositions;

FIG. 2 shows whiteness properties of molded parts made from polyester compositions after heating at 260° C. for 15 minutes;

FIG. 3 shows a compositional diagram in which the trapezoidal region delineated therein corresponds to polyester compositions.

### DETAILED DISCUSSION OF THE INVENTION

Additional aspects and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

The polyesters of the invention are polycondensation products of at least one aromatic hydroxycarboxylic acid monomer compound, at least one aromatic dicarboxylic acid monomer compound and at least one aromatic diol monomer compound. The polyesters of the invention contain the following structural units:

hydroquinone (I),

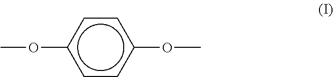

4,4′-biphenol (II),

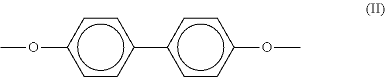

terephthalic acid (III),

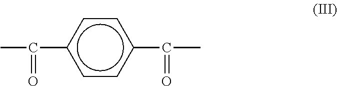

and p-hydroxybenzoic acid (V),

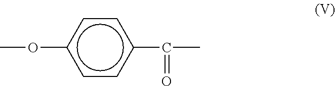

and, optionally in addition, isophthalic acid (IV)

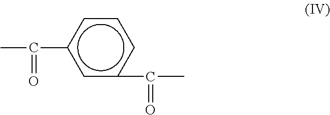

The polyester of the invention may further include one or more other aromatic or non-aromatic dicarboxylic acid monomer units other than terephthalic acid and isophthalic acid and preferably selected from the group consisting of 2,6-naphthalic dicarboxylic acid, 3,6-naphthalic dicarboxylic acid, 1,5-naphthalic dicarboxylic acid, 2,5-naphthalic dicarboxylic acid, 5-hydroxyisophthalic acid, 2,7-naphthalic dicarboxylic acid, 1,4-naphthalic dicarboxylic acid, 4,4′-dicarboxybiphenyl, and alkyl, aryl, alkoxy, aryloxy or halogen substituted derivatives thereof. The polyester of the invention may include one or more other aromatic diol monomer units other than 4,4′-biphenol and hydroquinone and preferably selected from the group consisting of resorcinol, 3,3′-biphenol, 2,4′-biphenol, 2,3′-biphenol, and 3,4′-biphenol, 2,6-dihydroxynaphthalene, 2,7-dihydroxynaphthalene, 1,6-dihydroxynaphthalene, 1,4-dihydroxynaphthalene, and alkyl, aryl, alkoxy, aryloxy or halogen substituted derivatives thereof. In other embodiments of the invention, the polyester may further include one or more hydroxycarboxylic acid monomers other than p-hydroxybenzoic acid and preferably selected from the group consisting of m-hydroxybenzoic acid, o-hydroxybenzoic acid, 4′-hydroxyphenyl-4-benzoic acid, 3′-hydroxyphenyl-4-benzoic acid, 4′-hydroxyphenyl-3-benzoic acid, 2,6-hydroxynaphthalic acid, 3,6-hydroxynaphthalic acid, 3,2-hydroxynaphthalic acid, 1,6-hydroxynaphthalic acid, and 2,5-hydroxynaphthalic acid, and alkyl, aryl, alkoxy, aryloxy or halogen substituted derivatives thereof.

The polyesters of the invention can optionally include one or more of the following structural units:

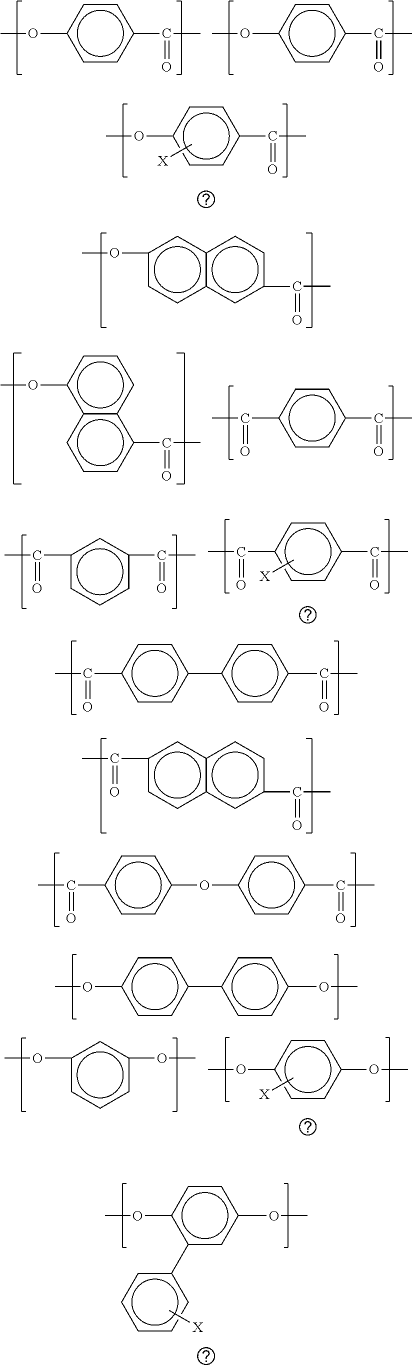

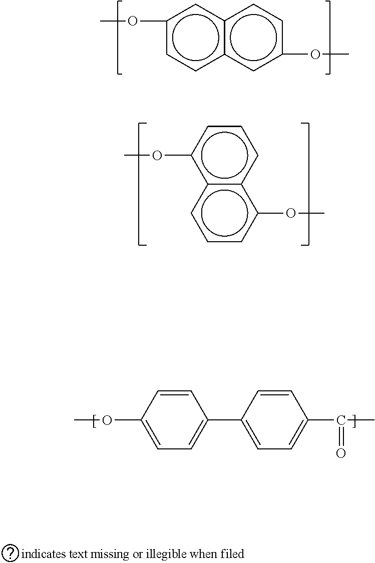

The polyesters of the invention comprise structural units (I), (II), (III), (IV) and (V) in the following amounts: 10-30 mole % of a mixture of hydroquinone (I) and 4,4′-biphenol (II); 10-30 mole % of diacid consisting of terephthalic acid (III) and, optionally in addition, isophthalic acid (IV); and 40-80 mole % of p-hydroxybenzoic acid (V), where mole % is based on the total number of moles of structural units (I), (II), (III), (IV) and (V) present in the polyester.

In another embodiment the polyesters of the invention comprise structural units (I), (II), (III), (IV) and (V) in the following amounts: 13-28.5 mole % of a mixture of hydroquinone (I) and 4,4′-biphenol (II); 13-28.5 mole % of diacid consisting of terephthalic acid (III) and, optionally in addition, isophthalic acid (IV); and 43-74 mole % of p-hydroxybenzoic acid (V) where mole % is based on the total number of moles of structural units (I), (II), (III), (IV) and (V) present in the polyester.

In the polyesters of the invention the mole ratio of the number of moles of structural units derived from isophthalic acid to the number of moles of structural units derived from terephthalic acid is from 0 to less than or equal 0.1. The polyesters of the invention may optionally include structural units derived from isophthalic acid.

In the polyester of the invention the ratio of the number of moles of structural units derived from hydroquinone to the number of moles of structural units derived from 4,4′-biphenol is from 0.1 to 1.50. Preferably the molar ratio of the number of moles of structural units derived from hydroquinone to the number of moles of structural units derived from 4,4′-biphenol is from 0.2 to 1.25, 0.4 to 1.00, 0.6 to 0.8, or 0.5 to 0.7.

In embodiments of the invention the molar ratio of structural units derived from hydroquinone and 4,4′-biphenol to structural units derived from terephthalic and isophthalic acid is preferably from 0.5 to 2, more preferably from 0.85 to 1.15, still more preferably from 0.95 to 1.05, the most preferably of about 1.00.

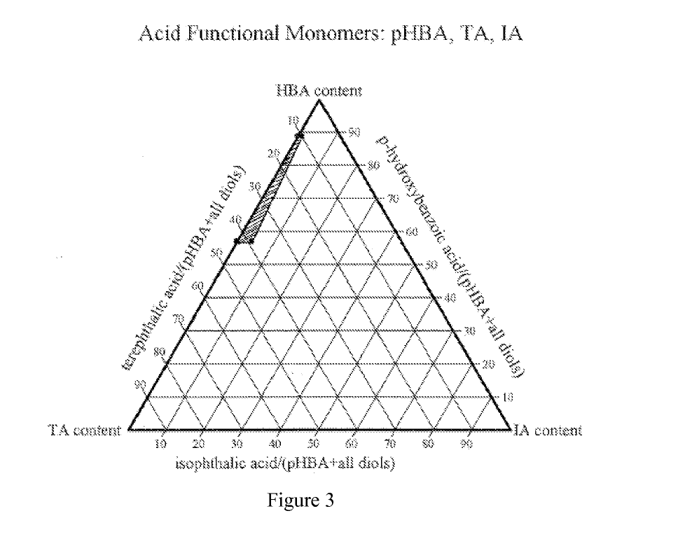

FIG. 3 is a compositional diagram showing a trapezoidal region corresponding to polyester compositions in one aspect of the invention in which the mole ratio of oxybenzoyl units to the sum of terephthalic and isophthalic unit is within the range of from about 1.33:1 to about 8:1, i.e., compositions containing 60 to 85 mol % of p-hydroxybenzoic acid with respect to sum of p-hydroxybenzoic acid and total diols and further defined by isophthalic acid content of 0% to 0.09 mol % with respect to sum of the moles of structural derived from isophthalic and terephthalic acid.

In the context of the invention the terms “monomer units”, “structural units”, “polymerized monomer units”, and “structural units derived from” refer to the chemical units present in the chemical structure of the polyesters in their respective polycondensed forms. Formulas (I), (II), (III), (IV) and (V) above show the structures of these units. The term “monomer compound” refers to the pure aromatic diol, aromatic dicarboxylic acid or aromatic hydroxycarboxylic acid compound as it exists before undergoing an alcohol/acid polycondensation reaction.

The polyester of the invention may optionally include up to 20 mole % of one or more other polymerized aromatic or non-aromatic structural units derived from one or more compounds other than p-hydroxybenzoic acid, terephthalic acid, isophthalic acid, hydroquinone and 4,4′-biphenol.

In a preferable embodiment of the invention, the polyester includes polymerized structural units that contain one or more naphthyl groups. For example, the polyester may include one or more of 3-hydroxy-2-naphthoic acid, 6-hydroxy-2-naphthoic acid, 2-hydroxynaphthalene-3,6-dicarboxylic acid, 2,6-naphthalic dicarboxylic acid, 3,6-naphthalic dicarboxylic acid, 1,5-naphthalic dicarboxylic acid, 2,5-naphthalic dicarboxylic acid, 2,7-naphthalic dicarboxylic acid, 1,4-naphthalic dicarboxylic acid, 2,6-dihydroxynaphthalene, 2,7-dihydroxynaphthalene, 1,6-dihydroxynaphthalene, 1,4-dihydroxynaphthalene, and alkyl, aryl, alkoxy, aryloxy or halogen substituted derivatives thereof.

Preferably, the polyester of the invention contains only structural units derived from p-hydroxybenzoic acid, terephthalic acid, isophthalic acid, hydroquinone and 4,4′-biphenol, or only structural units derived from p-hydroxybenzoic acid, terephthalic acid, hydroquinone and 4,4′-biphenol and is a wholly aromatic liquid crystalline polyester. Within the context of the invention, the polyester of the invention includes polycondensed reaction products made from a mixture of p-hydroxybenzoic acid, terephthalic acid, isophthalic acid, hydroquinone and 4,4′-biphenol, that further includes other aromatic and non-aromatic monomer compounds present as unavoidable or adventitious impurities in the aromatic monomer compounds.

In preferred embodiments the polyester of the invention comprises polymerized monomer units (i.e., polymerized structural units) in the following amounts: 50-70 mole % of p-hydroxybenzoic acid (V); 15 to 25 mole % of diacid consisting of terephthalic acid (III) and, optionally in addition, isophthalic acid (IV); and 15-25 mole % of a mixture of hydroquinone (I) and 4,4′-biphenol (II) where mole % is based on the total number of moles of I, II, III, IV and V. All values and subranges between the stated values are expressly included herein as if written out, for example, polymerized units of p-hydroxybenzoic acid may be present in a range of 45-75, 55-65, and about 60 mole %, the polymerized structural units of diacid consisting of terephthalic acid (III) and, optionally in addition, isophthalic acid (IV) may be present in amounts of 12.5-27.5, 22.5-27.5, and about 20 mole %; and the mixture of polymerized structural units of hydroquinone and 4,4′-biphenol may be present in amounts of 12.5-27.5, 27.5-22.5, and about 20 mole %. All numbers between the stated values are expressly included herein as if written out, e.g., values between an exemplary range of 22.5 to 27.5 mole % include 23, 24, 25, 26, and 27 mole %. Mole % is based on the total number of moles of structural units (I), (II), (III), (IV) and (V) present in the polyester.

In preferred embodiments the polyester of the invention comprises polymerized monomer units (i.e., polymerized structural units) in the amounts that satisfy the following formulas:

$$\begin{matrix}45 \% \leq \frac{V}{( I + II + III + IV + V )} \leq 75 \% & ( 1 ) \\ 0.1 \leq \frac{I}{II} \leq 1.50 & ( 2 ) \\ 0 \leq \frac{IV}{III} \leq 0.08 & ( 3 )\end{matrix}$$

where I, II, III, IV and V represent the molar amounts of the respective structural units shown in formulas (I), (II), (III), (IV) and (V) above.

In further preferred embodiments the polyester of the invention includes polymerized structural units in the following amounts: 55-65 mole % of p-hydroxybenzoic acid; 16 to 23 mole % of terephthalic acid; 0 to 2 mole % of isophthalic acid; 1.5 to 14 mole % of hydroquinone; and 7 to 21 mole % of 4,4′-biphenol. More preferable still are embodiments in which the polymerized structural units are present in the following amounts: 58-62 mole % of p-hydroxybenzoic acid; 18 to 21 mole % of terephthalic acid; 0.1 to 1.0 mole % of isophthalic acid; 3.2 to 12.6 mole % of hydroquinone; and 7.5 to 17.5 mole % of 4,4′-biphenol. As stated above, all numbers and subranges between the stated values are expressly included as if written out. In the case of isophthalic acid decimal amounts of the monomer compound are expressly included, for example the range 0.1-5 mole % includes 0.1, 0.2, 0.3, 0.4, 0.5, 0.6, 0.7, 0.8, 0.9, and 1.0 mole % as well as any decimal amount between 1.0 and 5 mole %. Preferably the amount of isophthalic acid is from 0 to 2.0 mole %; more preferably, the amount of isophthalic acid is between 0 and 1.5 mole %.

In further preferred embodiments the polyester of the invention includes polymerized structural units in the following amounts: 1.5 to 15 mole % of structural units derived from hydroquinone (I); 8 to 23 mole % of structural units derived from 4,4′-biphenol (II); 18 to 25 mole % of structural units derived from terephthalic acid (III); 0 to 2.5 mole % of structural units derived from isophthalic acid (IV); and 50-65 mole % of structural units derived from p-hydroxybenzoic acid (V); wherein mole % is based on the total number of moles of structural units (I), (II), (III), (IV) and (V) present in the polyester.

In further preferred embodiments the polyester of the invention includes polymerized structural units in the following amounts: 0.8 to 13.5 mole % of structural units derived from hydroquinone (I); 4 to 20.5 mole % of structural units derived from 4,4′-biphenol (II); 9 to 22.5 mole % of structural units derived from terephthalic acid (III); 0 to 2 mole % of structural units derived from isophthalic acid (IV); and 55-60 mole % of structural units derived from p-hydroxybenzoic acid (V); wherein mole % is based on the total number of moles of structural units (I), (II), (III), (IV) and (V) present in the polyester.

In further preferred embodiments the polyester of the invention comprises polymerized monomer units (i.e., polymerized structural units) in the amounts that satisfy the following formulas:

$$\begin{matrix}45 \% \leq \frac{V}{( I + II + III + IV + V )} \leq 70 \% & ( 4 ) \\ 0.2 \leq \frac{I}{II} \leq 1.25 & ( 5 ) \\ 0 \leq \frac{IV}{III} \leq 0.05 & ( 6 )\end{matrix}$$

In a preferred embodiment, the total number of moles of the structural units (I), (II), (III), (IV) and (V) is of at least 95 mole % (preferably at least 96, at least 97, at least 98 or at least 99 mole %) based on the total number of moles of all structural units. In a related other preferred embodiment the polyester of the invention includes at least 95 mole %, preferably 96, 97, 98 or 99 mole % of structural units derived from p-hydroxybenzoic acid, terephthalic acid, isophthalic acid, hydroquinone and 4,4′-biphenol, with no more than 5, 4, 3, 2, 1 mole % of structural units derived from unavoidable or adventitious impurities present in the aromatic monomer compounds. In an especially preferred embodiment of the invention the polyester of the invention includes only structural units derived from p-hydroxybenzoic acid, terephthalic acid, isophthalic acid, hydroquinone and 4,4′-biphenol.

In other embodiments the polyester of the invention includes at least 50 mole %, preferably 60, 70, 80, or 90 mole % of structural units derived from p-hydroxybenzoic acid, terephthalic acid, isophthalic acid, hydroquinone and 4,4′-biphenol, with the balance of structural units representing other aromatic or non-aromatic monomer structural units. For example the polyester of the invention may preferably contain one or more alicyclic, aliphatic, aromatic and/or non-aromatic structural units such as the structural units described in the publications incorporated herein by reference. Preferably the polyester of the invention includes one or more alicyclic structural units derived from a cis, trans mixture of 1,3-cyclohexanedicarboxylic acid, 1,4-cyclohexanedicarboxylic acid, trans-1,4-cyclohexanedicarboxylic acid, 1,4-cyclohexanediol, 1,3-cyclohexanediol, and 1,4-cyclohexanedimethanol.

In the polyester of the invention the mole ratio of the number of moles of structural units derived from isophthalic acid to the number of moles of structural units derived from terephthalic acid can be notably from 0 to 0.08; it is preferably from 0.01 to less than 0.1, more preferably 0.02-0.5, 0.03-0.4. As stated above, fractions and decimal amounts are expressly included as if written out, e.g., the range 0.01-0.5 includes 0.01, 0.02, 0.03, 0.04, 0.05, 0.06, 0.07, 0.08, 0.09, 0.10, 0.2, 0.3, and 0.4 and any fraction, decimal value and subrange between the stated values.

In the polyester of the invention the mole ratio of the number of moles of structural units derived from hydroquinone to the number of moles of structural units derived from 4,4′-biphenol is preferably 0.2-1.20, more preferably 0.3-1.1, 0.4-1.0, 0.5-0.9, 0.6-0.8, 0.65-0.75. As stated above, fractions and decimal amounts are expressly included as if written out, e.g., the range 0.2-0.1.15 includes 0.21-1.14, 0.23-1.07, 0.37-0.85, and any fraction, decimal value and subrange between the stated values.

Compositions comprising the polyester of the invention are included in the invention. Compositions comprising the invented wholly aromatic polyester as detailed hereinafter are also included in the invention. Compositions comprising the polyester manufactured by the invented manufacturing process as detailed hereinafter are also included in the invention. All these compositions may contain any amount of the polyester of the invention (or of the other two cited polyesters). Preferable compositions include mixtures of materials in which the polyester is the only organic thermoplastic material and is present in amounts of at least 50% by weight based on the total weight of the composition.

Examples of other components which may be present in the compositions containing with the polyester include fibrous, lamellar or particulate fillers and/or reinforcements. Fibrous fillers and/or reinforcements include glass fiber, silica-alumina fiber, alumina fiber, carbon fiber and aramid fiber. Examples of lamellar or particulate fillers and/or reinforcements may include talc, mica, graphite, wollastonite, calcium carbonate, dolomite, clay, glass flake, glass beads, mineral wool, barium sulfate and titanium oxide. Particulate fillers having a high thermal conductivity are preferred.

The fillers and/or reinforcements are present in compositions of the polyester of the invention in amounts of 0.1-200 parts by weight, preferably 10-100 parts by weight per 100 parts by weight of the polyester. If the amount of the fillers and/or reinforcements is more than 200 parts by weight, the moldability of the resulting polyester resin composition tends to be decreased or the ablation of the cylinder or die of the molding device tends to be increased.

The polyester-containing composition according to the present invention may further include one or more additives, which are conventionally used for resin compositions, if desired. For example, molding lubricant such as higher aliphatic acid, higher aliphatic ester, higher aliphatic amide, higher aliphatic acid metal salt (wherein, the term “higher” means a monomer unit of such a material has from 10 to 25 carbon atoms), polysiloxane and fluorocarbon resin; colorant such as dyes and pigments; antioxidant; thermal stabilizer; UV absorbent; antistatic agent; and surface active agent may be admixed. These additives may be present in the polyester resin composition of the invention in an amount of 0.005-1 parts by weight, preferably 0.01-0.5 parts by weight per 100 parts by weight of the polyester.

Molding lubricants such as higher aliphatic acid, higher aliphatic ester, higher aliphatic acid metal salt or fluorocarbon-type surfactant may be added to the pellets of the liquid-crystalline polyester resin or the polyester before subjecting the pellets to the molding process, so that the agent adheres to the outer surface of the pellet.

Optionally the polyester-containing composition contains one or more thermal stabilizers, whiteners or optical brighteners. Preferred thermal stabilizers include monophenols such as, for example, 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexcylphenol, 2,6-di-tert-butyl-4-methoxymethylphenol, 2,6-dinonyl-4-methylphenol, 2,4-dimethyl-6-(1′-methyl-undec-1′-yl)phenol, 2,4-dimethyl-6-(1′-methylheptadecyl-1′-yl)phenol, 2,4-dimethyl-6-(1′-methyl-tridec-1′-yl)phenol, and mixtures thereof; alkylthiomethylphenols, for example, 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol; hydroquinone and alkylated hydroquinones, for example, 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butyl-hydroquinone, 2,5-di-tert-butyl-4-hydroxyanisole, 3,5-di-tert-butyl-4-hydroxyanisole, 3,5-di-tert-butyl-4-hydroxyphenyl stearate, and bis-(3,5-di-tert-butyl-4-hydroxyphenyl)adipate; a cumarone derivative, for example, α-tocopherol, β-tocopherol, γ-tocopherol, γ-tocopherol, and mixtures thereof; hydroxylated thiodiphenylethers, for example, 2,2′-thiobis(6-tert-butyl-4-methylphenol), 2,2′-thiobis(4-octylphenol), 4,4′-thiobis(6-tert-butyl-3-methylphenol),4,4′-thiobis(6-tert-butyl-2-methylphenol), 4,4′-thio-bis(3,6-di-sec-amylphenol), 4,4′-bis-(2,6-dimethyl-4-hydroxyphenyl)disulphide; alkylidene bisphenols, for example, 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-(α-methylcyclohexylphenol, 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylidenebis[6-(α-methylbenzyl)-4-nonylphenol], 2,2′-methylidenebis[6-(α,α-dimethylbenzyl)-4-nonylphenol], 4,4′-methylidenebis(2,6-di-tert-butylphenol), 4,4′-methylidenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, -ethyleneglycolbis[3,3-bis(3′-tert-butyl-4′-hydroxyphenyl)butylate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methlyphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)-pentane; O-, N- and S-benzyl compounds, for example, 3,5,3′,5′-tetra-tert-butyl-4,4′-dihydroxybenzylether, octadecyl 4-hydroxy-3,5-dimethylbenzyl-mercaptoacetate, tridecyl4-hydroxy-3,5-di-tert-butylbenzyl-mercaptoacetate, tris(3,5-di-tert-butyl-4-hydroxybenzyl)amine, bis(4-tert-butyl-3-hydroxy-2,6-dimethylbenzyl)dithiophthalate, bis(3,5-di-tert-butyl-4-hydroxybenzyl)sulphide, isooctyl3,5-di-tert-butyl-4-hydroxybenzyl-mercaptoacetate; hydroxybenzylmaloates, for example, 2,2-bis(3,5-di-tert-butyl-4-hydroxy-5-methylbenzyl)dioctadecyl maloate, 2,2-bis(3,5-di-tert-butyl-4-hydroxybenzyl)di-dodecyl mercaptoethylmaloate, 2,2-bis(3,5-di-tert-butyl-4-hydroxybenzyl)maloatebis[4-(1,1,3,3-tetramet-hylbutyl)-phenyl]; a hydroxybenzyl aromatic compound, for example, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol; triazine compounds, for example, 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,3,5-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate; benzylphosphonates, for example, 2,5-di-tert-butyl-4-hydroxybenzyldimethylphosphonate, 3,5-di-tert-butyl-4-hydroxybenzyldiethylphosphonate, 3,5-di-tert-butyl-4-hydroxybenzyldioctadecylphosphonate, 3,5-di-tert-butyl-4-hydroxy-3-methylbenzyldioctadecylphosphonate, calcium salt of 3,5-di-tert-butyl-4-hydroxybenzylmonoethylphosphonate; acylaminophenols, for example, lauric 4-hydroxyanilide, stearic 4-hydroxyanilide, octylN-(3,5-di-tert-butyl-4-hydroxyphenyl)-carbamate; an ester of the following mono or polyvalent alcohol with β-(3,5-di-tert-butyl-4-hydroxyphenyl)propionate, an example of the alcohol: methanol, ethanol, n-octanol, isooctanol, octadecanol, 1,6-hexanediol, 1,9-nonanediol, ethyleneglycol, 1,2-propanediol, neopentylglycol, thiodiethyleneglycol, diethyleneglycol, triethyleneglycol, pentaerythritol, tris(hydroxyethyl)isocyanurate, N,N′-bis(hydroxyethyl)succinic diamide, 3-thiaundecanol, 3-thiapentadecanol, trimethylhexanediol, trimethylol propane, 4-hydroxymethyl-1-phospha-2,6,7-trioxabicyclo[2,2,2]octane; an ester of the following mono or polyvalent alcohol with β-(5-tert-butyl-4-hydroxy-3-methylphenyl)propionate, an example of the alcohol: methanol, ethanol, n-octanol, isooctanol, octadecanol, 1,6-hexanediol, 1,9-nonanediol, ethyleneglycol, 1,2-propanediol, neopentylglycol, thiodiethyleneglycol, diethyleneglycol, triethyleneglycol, pentaerythritol, tris(hydroxyethyl) isocyanurate, N,N′-bis(hydroxyethyl)succinic diamide, 3-thiaundecanol, 3-thiapentadecanol, trimethylhexanediol, trimethylol propane, 4-hydroxymethyl-1-phospha-2,6,7-trioxabicyclo[2,2,2]octane; an ester of the following mono or polyvalent alcohol with β-(3,5-dicyclohexyl-4-hydroxyphenyl)propionate, an example of the alcohol: methanol, ethanol, n-octanol, isooctanol, octadecanol, 1,6-hexanediol, 1,9-nonanediol, ethyleneglycol, 1,2-propanediol, neopentylglycol, thiodiethyleneglycol, diethyleneglycol, triethyleneglycol, pentaerythritol, tris(hydroxyethyl)isocyanurate, N,N′-bis(hydroxyethyl)succinic diamide, 3-thiaundecanol, 3-thiapentadecanol, trimethylhexanediol, trimethylol propane, 4-hydroxymethyl-1-phospha-2,6,7-trioxabicyclo[2,2,2]octane; an ester of the following mono or polyvalent alcohol with β-3,5-di-tert-butyl-4-hydroxyphenyl)acetate, an example of the alcohol: methanol, ethanol, n-octanol, isooctanol, octadecanol, 1,6-hexanediol, 1,9-nonanediol, ethyleneglycol, 1,2-propanediol, neopentylglycol, thiodiethyleneglycol, diethyleneglycol, triethyleneglycol, pentaerythritol, tris(hydroxyethyl)isocyanurate, N,N′-bis(hydroxyethyl)succinic diamide, 3-thiaundecanol, 3-thiapentadecanol, trimethylhexanediol, trimethylol propane, 4-hydroxymethyl-1-phospha-2,6,7-trioxabicyclo[2,2,2]octane; β-(3,5-di-tert-butyl-4-hydroxyphenyl)propionic amide, for example, N,N′-bis(3,5-di-tert-butyl-4-hydroxyphenylpropionyl)hexamethylene diamine, N,N′-bis(3,5-di-tert-butyl-4-hydroxyphenylpropionyl)trimethylene diamine, N,N′-bis(3,5-di-tert-butyl-4-hydroxyphenylpropionyl)hydrazine; an amine-based antioxidant, for example, N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(naphtyl)-p-phenylenediamine, N-isopropyl-N′-phenyl-p-phenylenediamine, N-(1,3-dimethylbutyl-N′-phenyl-p-phenylenediamine, N-(1-methylheptyl)-N′-phenyl-p-phenylenediamine, N-cyclohexyl-N′-phenyl-p-phenylenediamine, 4-(p-toluenesulphamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphtylamine, N-(4-tert-octylphenyl)-1-naphtylamine, N-phenyl-2-naphtylamine, octylated diphenylamine, for example, p,p′-di-tertiary-butyloctyl diphenylamine, 4-n-butylaminophenol, 4-butylylaminophenol, 4-nonanoyl aminophenol, 4-dodecanoylaminophenol, 4-octadodecanoylaminophenol, bis(4-methoxyphenyl)amine, 2,6-d-tertiarybutyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)aminoethane, 1,2-bis(phenylamino)propane, (o-tolyl)biguanide, bis[4-(1′,3′-dimethylbutyl)phenyl]amine, tertiary-octylated N-phenyl-1-naphtylamine, a mixture of a mono- and dialkylated tert-butyl/tert-octyldiphenylamine, a mixture of a mono- and dialkylated tert-butyl/tert-nonyldiphenylamine, a mixture of a mono- and dialkylated tert-butyl/tert-dodecyldiphenylamine, a mixture of a mono- and dialkylated isopropyl/isohexcyldiphenylamine, a mixture of a mono- and dialkylated tert-butyldiphenylamine, 2,3-dihydro-3,3-dimethyl-4H-1,4-benzothiadine, phenothiadine, a mixture of a mono- and dialkylated tert-butyl/tert-octylphenothiadine, a mixture of a mono- and dialkylated tert-butyloctylphenothiadine, N-allylphenothiadine, N,N,N′,N′-tetrapheyl-1,4-diaminobuto-2-en, N,N-bis(2,2,6,6-tetramethyl-pyperido-4yl)hexamethylenediamine, bis(2,2,6,6-tetramethylpyperido-4-yl)sebacate, 2,2,6,6-tetramethyl-pyperidine-4-ol; 2-(2′-hydroxyphenyl)benzotriazole, for example, 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methyl-phenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octylcarbonylethyl)phenyl)-5-chloro-benzotriazole, and a mixture thereof, 2-(3′-tert-butyl-5′-[2-(2-ethylhexyloxy)carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-2′-hydroxy-5′-[2-(2-ethylhexyloxy)-carbonylethyl]-2′-hydroxyphenyl)benzotriazole, 2-(3′-dodecyl-2′-hydroxy-5′-methylphenyl)benzotriazole, and 2-(3′-tert-butyl-2′-hydroxy-5′-(2-isooctyloxycarbonylethyl)phenyl)benzotriazole, and 2,2′-methylene-bis[4-(1,1,3,3-tetramethylbutyl)-6-benzotriazole-2-yl-phen-ol]; an esterification product of 2-[3′-tert-butyl-5′-(2-methoxycarbonylethyl)-2′-hydroxyphenyl]-2H-benzotriazole with polyethyleneglycol 300; [R—CH₂CH₂—COO(CH₂)₃]₂ (in the formula, R=3′-tert-butyl-4′-hydroxy-5′-2H-benzotriazole-2-yl-phenyl); 2-hydroxybenzophenone, for example, 4-hydroxy-, 4-methoxy-, 4-octyloxy-, 4-decyloxy-, 4-dodecyloxy-, 4-benzyloxy-, 4,2,4-trihydroxy-, and 2′-hydroxy-4,4′-dimethoxy-derivatives; a substituted and nonsubstituted ester of benzoic acid, for example, 4-tert-butylphenyl salicylate, phenyl salicylate, octylphenyl salicylate, dibenzoyl resorcinol, bis(4-tert-butylbenzoyl)resorcinol, benzoyl resorcinol, 3,5-di-tert-butyl-4-hydroxy benzoicacid 2,4-di-tert-butylphenyl, 3,5-di-tert-butyl-4-hydroxy benzoic acid hexadecyl, 3,5-di-tert-butyl-4-hydroxy benzoic acid 2-methyl-4,6-di-tert-butylphenyl; a hindered amine-, for example, bis(2,2,6,6-tetramethyl-4-pyperidyl)sebacate, bis(2,2,6,6-tetramethyl-4-pyperidyl)succinate, bis(1,2,2,6,6-pentamethyl-4-pyperidyl)sebacate, n-butyl-3,5-di-tert-butyl-4-hydroxybenzyl maloatebis(1,2,2,6,6-pentamethyl-4-pyperidyl), a condensation product of 1-(2-hydroxyethyl)-2,2,6,6-tetramethyl-4-hydroxypyperidine with succinic acid, a condensation product of 1-N,N′-bis(2,2,6,6-tetramethyl-4-pyperidyl)hexamethylenediamine with 4-tert-octyl-amino-2,6-dichloro-1,3,5-triazine, nitrylotriacetictris(2,2,6,6-tetramethyl-4-pyperidyl), 1,2,3,4-butanetetracarboxylic acid tetrakis(2,2,6,6-tetramethyl-4-pyperidyl), 1,1′-(1,2-ethanedyl)-bis(3,3,5,5-tetramethylpyperadinone)4-benzoyl-2,2,6,-6-tetramethylpyperidine, 4-stearyloxy-2,2,6,6-tetramethylpyperidine, 2-n-butyl-2-(2-hydroxy-3,5-di-tert-butylbenzyl)malonic acid bis(1,2,2,6,6-pentamethylpyperidyl), 3-n-octyl-7,7,9,9-tetramethyl-1,3,8-triazaspyro[4,5]decane-2,4-dion, bis(1-octyoxy-2,2,6,6-tetramethylpyperidyl)sebacate, bis(1-octyoxy-2,2,6,6-tetramethylpyperidyl)succinate, a condensation product of N,N′-bis(2,2,6,6-tetramethyl-4-pyperidyl)hexamethylenediamine with 4-morpholino-2,6-dichloro-1,3,5-triazine, a condensation product of 2-chloro-4,6-bis(4-n-butylamino-2,2,6,6-tetramethyl-4-pyperidyl)-1,3,5-triazine with 1,2-bis(3-aminopropylamino)ethane, a condensation product of 2-chloro-4,6-bis(4-n-butylamino-1,2,2,6,6-pentmethyl-4-pyperidyl)-1,3,5-triazine with 1,2-bis(3-aminopropylamino)ethane, 8-acetyl-3-dodecyl-7,7,9,9-tetramethyl-1,3,8-triazaspyro[4,5]decane-2,4-d-ion, 3-dodecyl-1-(2,2,6,6-tetramethyl-4-pyperidyl)pyrodine-2,5-dion, 3-dodecyl-1-(1,2,2,6,6-pentamethyl-4-pyperidyl)pyrodine-2,5-dion, a mixture of 4-hexadecyloxy- and 4-stearyloxy-2,2,6,6-tetramethylpyperidines, a condensation product of N,N′-bis(2,2,6,6-tetramethyl-4-pyperidyl)hexamethylenediamine with 4-cyclohexylamino-2,6-di-chloro-1,3,5-triazine, a condensation product of 1,2-bis(3-aminopropylamino)ethane with 2,4,6-trichloro-1,3,5-triazine, and 4-butylamino-2,2,6,6-tetramethyl-4-pyperidine (CAS Reg. No. [136504-96-6]); N-(2,2,6,6-tetramethyl-4-pyperidyl)-n-dodecyl succinimide, N-(1,2,2,6,6-pentmethyl-4-pyperidyl)-n-dodecyl succinimide, 2-undecyl-7,7,9,9-tetramethyl-1-oxa-3,8-diaza-4-oxo-spyro[4,5]decane, a reaction product of 7,7,9,9-tetramethyl-2-cycloundecyl-1-oxa-3,8-diaza-4-oxo-spyro[4,5]decane with epichlorohydrin; 2-(2-hydroxyphenyl)-1,3,5-triazine, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propyloxy)phenyl]-4,6-bis(2,4-dimethylphenyl)-1,3,5-triazine, 2[2-hydroxy-4-(2-hydroxy-4-(2-hydroxy-3-octloxy-propyloxy)phenyl]-4,6-bis(−2,4-dimethylphenyl)-1,3,5-triazine, 2-[4-(dodecyloxy/tridecyloxy-2-hydroxypropoxy)-2-hydroxyphenyl]-4,6-bis(2-,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine,2-(2-hydroxy-4-hexyloxy)phenyl-4,6-diphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine-, 2-(2-hydroxyphenyl)-4-(4-methoxyphenyl)-6-phenyl-1,3,5-triazine; a phosphite or a phosphonite, for example, triphenyl phosphonite, diphenyl phosphonite alkyl, phenylphosphonite dialkyl, trisnonylphenyl phosphonite, lauryl phosphonite, trioctadecyl phosphonite, distearyl pentaerythritol diphosphite, tris(2,4-di-tert-butyl-phenyl)phosphonite, diisodecyl pentaerythritol diphosphite, bis(2,4-di-tert-butyl-4-methylphenyl)pentaerythritol diphosphite, bis(2,6-di-tert-butyl-4-methylphenyl)pentaerythritoldiphosphite, bis-isodecyl pentaerythritol diphosphite, bis(2,4-di-tert-butyl-6-ethylphenyl)pentaerythritol diphosphite, bis(2,4,6-tri-tert-butyl-6-methylphenyl)pentaerythritol diphosphite, tetrakis(2,4-di-tert-butylphenyl)4,4′-biphenylenephosphite, 6-isooctyloxy-2,4,8,10-tetra-tert-butyl-12H-dibenz[d,g]-1,3,2-dioxaphosphocine, 6-fluoro-2,4,8,10-tetra-tert-butyl-12-methyl-dibenz[d,g]-1,3,2-dioxaphosphocine, bis(2,4-di-tert-butyl-6-methylphenyl)methyl phosphite, and bis(2,4-di-tert-butyl-6-methylphenyl)ethyl phosphite. Of those, tris(2,4-di-tert-butylphenyl)phosphite is preferred.

Optical brighteners include bisbenzoxazoles, phenylcoumarins and bisstearylbiphenyls, in particular phenylcoumarin, and particularly preferably triazine phenylcoumarin, commercially available as Tinopal™ (Ciba-Geigy, Basle, Switzerland), or Hostalux™ KS (Clariant, Germany), or Eastobrite™ OB-1 (Eastman). In a preferred embodiment of the present invention, the polyester-containing composition further comprises at least one optical brightener.

The polyester-containing composition of the present invention may comprise one or more additional resin components. Examples of the additional resin components include thermoplastic resins such as polyamide, polyester, polyphenylene sulfide, polyether ketone, polycarbonate, polyphenylene ether and denatured derivatives thereof, polysulfone, polyethersulfone and polyether imide and thermosetting resins such as phenol resin, epoxy resin and polyimide resin. The amount of the additional resin component is not limited, and may be determined dependent on the intended property. Typically, such additional resins may be added to the polyester resin composition in an amount of 1-200 parts by weight, preferably 10-100, 20-80, 30-70, 40-60 and about 50 parts by weight per 100 parts by weight of the polyester resin.

The polyester-containing composition of the invention may be obtained by adding fillers, reinforcements and other resin components to the polyester resin and melt kneading the mixture using a kneading machine such as Banbury mixer, kneader, single screw extruder, twin screw extruder or the like.

The polyester-containing composition of the invention may be molded using a conventional melt molding process, preferably injection molding, compression molding, extrusion molding and blow molding. The molded articles obtained according to the present invention are particular useful for manufacturing parts of electric and electronic devices, machines and automobiles.

The polyester of the invention is advantageously formed by polycondensing a monomer mixture comprising the monomer compounds terephthalic acid; p-hydroxybenzoic acid; 4,4′-biphenol; and hydroquinone; the monomer mixture may further comprise notably isophthalic acid. The monomer mixture comprises typically the monomer compounds in the relative ratios described above for the polyester of the invention.

Hence, an aspect of the present invention is directed to a process for manufacturing a polyester, comprising:

forming an initial monomer mixture comprising 40-80 mole % of p-hydroxybenzoic acid, 10 to 30 mole % of a diol mixture consisting of hydroquinone and 4,4′-biphenol, and 10 to 30 mole % of diacid consisting of terephthalic acid and, optionally in addition, isophthalic acid, wherein mole % is based on the total number of moles of p-hydroxybenzoic acid, hydroquinone, 4,4′-biphenol, terephthalic acid and isophthalic acid present in the initial monomer mixture;

wherein the molar ratio of hydroquinone to 4,4′-biphenol is from 0.1 to 1.5;
wherein the molar ratio of isophthalic acid to terephthalic acid is from 0 to 0.1; and
wherein at least 80 mole % of all of the monomers of the initial monomer mixture are aromatic monomer compounds;
reacting the monomers of the initial monomer mixture to form the polyester.

The polyester manufactured by the invented process is advantageously the polyester of the invention as above detailed, or the invented wholly aromatic polyester as detailed hereinafter.

In the invented process, the molar ratio of (hydroquinone+4,4′-biphenol)/(terephthalic acid+isophthalic acid) is advantageously from 0.5 to 2, preferably from 0.95 to 1.05.

The polycondensation is preferably carried out by first subjecting the monomer mixture to an acylation reaction. Typically, the acylation reaction includes reacting the hydroxyl groups of the monomer compounds, e.g., the phenolic hydroxyl groups of hydroquinone, 4,4′-biphenol, and hydroxybenzoic acid, with an acylation agent such as acetic anhydride.

Accordingly, the invented process preferably further comprises:

mixing the initial monomer mixture with an acylating agent to form an acylation mixture;
wherein the reacting comprises:
heating the acylation mixture to a first temperature to form an acylated monomer mixture; and
heating the acylated monomer mixture to a second temperature to carry out solid state polycondensation of the acylated monomer mixture.

The acylation agent is advantageously an anhydride of a monocarboxylic acid, preferably an anhydride of a C₂ to C₄ monocarboxylic acid, more preferably acetic anhydride.

The acylation agent is beneficially added in at least stoichiometric amounts.

Preferably the entire amount of the hydroquinone present in the acylation reaction mixture is acylated with an acylation reagent. More preferably the entire amounts of both the 4,4′-biphenol and hydroquinone are fully acylated in the acylation mixture. Even more preferably the entire amounts of the 4,4′-biphenol, the hydroquinone and the hydroxyl benzoic acid are fully acylated in the acylation mixture.

In one embodiment of the process for the making the polyester of the invention the hydroxyl group-containing monomer compounds are acylated separately, e.g., apart from the other monomer compounds. After the hydroxyl-containing monomer compounds are acylated separately, the acylated monomer compounds are mixed with the other monomer compounds and subsequently subjected to polycondensation.

In other embodiments of the invention one or more of the hydroxyl-containing monomers is separately acylated then mixed with the other monomer compounds before the polycondensation is carried out. For example, one or more of the hydroxyl-containing monomers may be separately acylated, e.g., the hydroquinone, the 4,4′-biphenol, the p-hydroxybenzoic acid, or combinations thereof, is acylated separately then mixed with any of the monomer compounds (acylated and/or unacylated) prior to carrying out polycondensation.

In a most preferred embodiment all of the monomer compounds and catalysts are mixed together in batch or continuous fashion, then mixed with an acylating agent whereby all of the hydroxyl-containing monomer compounds are fully acylated. A fully acylated hydroxyl-containing monomer compound is one in which all of the hydroxyl groups attached to the monomer compound have reacted with the acylating agent. Preferably, the monomer mixture is reacted with the acylating agent to form a mixture in which all of the hydroxyl groups of the hydroquinone, the 4,4′-biphenol, and the p-hydroxybenzoic acid are acylated.

After the acylation is complete, acetic acid formed during the acylation is preferably removed.

The acylation is carried out by mixing the acylating agent, e.g., acetic anhydride, with the monomer mixture and the catalyst to form a solid, semi-liquid or liquid mixture which is heated to a temperature of from about 130° C. to a temperature of 160° C., preferably 135-155° C., most preferably about 145° C., for a period of from 10 minutes to 10 hours, most preferably 1 hour with stirring to form an acylated mixture.

Preferably the amount of acylating agent used in the acylation reaction is at least the stoichiometric equivalent of all hydroxyl groups in the monomer compound mixture. For example, if the monomer compound mixture contains 1 mole of hydroquinone, 1 mole of 4,4′-biphenol and 1 mole of p-hydroxybenzoic acid, the total number of moles of the acylating agent, e.g., acetic anhydride, is 5 moles. Preferably the acylation is carried out by with an excess of the acylation agent over the stoichiometric amount, for example the acylation agent may be used in amounts of 0-30 mole %, 0-20 mole %, more preferably 0-15 mole % excess based on the total number of moles of aromatic hydroxyl groups present in the monomer mixture. Preferably all of the hydroxyl groups present in the monomer mixture are acylated and there is no more than a 10% molar excess of the acylating agent, preferably no more than a 9, 8, 7, 6, 5, 4, 3, 2, 1, 0.5, 0.1, 0.05, 0.01% molar excess of the acylating agent present in the acylated monomer mixture.

The polycondensation of the acylated mixture is preferably carried out by increasing heat input to distill off the carboxylic acid side product. The temperature of the reaction mixture increases from 145 to 310° C. over about five hours.

In the preferred embodiment the pre-polymer mixture is cooled under nitrogen in the reaction vessel in which the acylation was carried out, or first transferred to a cooling vessel and then allowed to cool and form a solid acylated reaction product. The cooled solid product may then be chipped or crushed to provide the acylated mixture in a granulated or powder form.

The resulting solid acylated mixture is then subjected to a solid state polycondensation by heating the solid acylated product at an elevated temperature in an inert atmosphere such as nitrogen.

The solid state polycondensation is preferably carried out at a temperature of greater than 250° C., preferably in a temperature range of 250-350° C. for 1 to 24 hours. In a most preferred embodiment the solid state polycondensation is carried out at a temperature that is less than the melting temperature of the desired polyester during the entire course of the polycondensation reaction.

The acylation and/or polycondensation steps may be carried out in the presence of a catalyst. Preferably a catalyst is used in both the polycondensation and the acylation. A preferred variant of the polycondensation reaction is described in U.S. Pat. No. 4,742,149, incorporated herein by reference in its entirety, which comprises adding a salt, particularly an alkaline earth metal salt or an alkali metal salt, for example an organic or inorganic salt of lithium, sodium, potassium, beryllium, magnesium, calcium, barium and mixtures thereof, preferably an alkaline earth salt of a carboxylic acid such as acetate, preferably potassium sulfate, during the preparation of the resin and, particularly to the prepolymer melt prior to advancement of the final product to the desired degree of polymerization. The incorporation of stabilizing amounts of phosphites, as described in U.S. Pat. No. 4,639,504 is also advantageous. Catalysts may include an organic tin compound, such as dialkyl tin oxide, preferably dibutyl tin oxide, titanium compounds such as titanium alkoxides and titanium dioxide, metal oxides such as antimony trioxide, alkoxy titanium silicates, and metal dihydrogen phosphates such as sodium dihydrogen phosphate, potassium dihydrogen phosphate, and lithium dihydrogen phosphate. The catalysts described in U.S. Pat. No. 5,089,594, incorporated herein by reference in its entirety, may be used in the process of the invention. When present during the polycondensation the catalyst is preferably present in an amount of from 10 to 5,000 ppm, more preferably 20-200 ppm based on the total amount of monomers.

The acetylation reaction takes place at about 140° C. for a period of time of from about 0 to about 6 hours. The reaction mixture is then heated to about 240° C. to about 320° C. at a rate of about 20° C. to about 80° C. per hour, and is kept at about 240° C. to about 320° C. for approximately a few minutes to about 4 additional hours. The low molecular weight polymer obtained is then solid state advanced to the required high molecular weight by heating to a temperature of from about 250° C. to about 350° C., as described above, for a period of from about one to about 24 hours.

After completion of the solid-state polycondensation reaction, the resulting polyester is cooled under nitrogen. Preferably the polyester is rapidly cooled by turning the oven off and cooling the reaction vessel under nitrogen.

The polyester of the invention has low color with high whiteness retention, ease of processing and excellent mechanical properties at high temperature.

The melting point (Tm) of the polyester of the invention is preferably less than 400° C. and greater than 300° C., more preferably less than 390° C. and greater than 325° C., especially preferably about 375° C. The word “about” is used to mean that the temperature may vary by ±20° C. around the stated temperature. Therefore, a temperature of “about” 375° C. includes temperatures of 365, 366, 367, 368, 369, 370, 371, 372, 373, 374, 375, 376, 377, 378, 379, 380, 381, 382, 383, 384, and 385° C. In a preferred embodiment the polyester of the invention has a melting point of 370-380° C. or 360-385° C.

The polyester of the invention exhibits an outstanding balance of properties.

The polyester of the invention has usually improved color properties in comparison to conventional polyesters and LCPs. These improved color properties can be expressed by a variety of measurements of white light reflectance, each of which can quantify the observed higher whiteness and lower yellowness of the resin and compounds of this invention compared to conventional resins and compounds. These measurements are known to those skilled in the art. The whiteness of the polyester of the invention is determined by calculating the color difference in the presence of D6500 illumination between the finely ground resin powder and a white reference tile using the CIELAB ΔE* (Delta E) equation according to ASTM E308-06. A resin having a relatively lower ΔE* is indicative of improved whiteness. Preferably the polyester of the invention has a ΔE* of less than 25, more preferably less than 24, 23, 22, 21, or 20 or 19, 18, 17, 16, 15, 14, 13, 12, 11, or 10 it is especially preferred that the polyester of the invention has a ΔE* of less than 22.

The polyester of the invention preferably has a heat distortion temperature of at least 280° C., preferably at least 290° C., most preferably at least 300° C. and higher according to either ASTM D648, at stress level 264 psi or ISO 75, at stress level 1.82 MPa. A higher heat distortion temperature is indicative of a resin that tends to exhibit stiffness and less sag at high temperatures.

Properties of ductility, which are advantageous for molded part applications and processing, can be evaluated with diverse test procedures known to those skilled in the art. For example, tensile elongation stress and strain at break and flex stress and strain at break are useful measures of ductility for polyester resins and compounds. The polyester of the invention preferably has a flex strain at break of at least 1.0% and a flex stress at break of at least 10,000 psi according to ASTM D790 at strain rate of 0.05″/min or according to ISO 178 at strain rate 2 mm/min.

The polyester of the invention preferably has a melt viscosity at 380° C. of from 500 to 2500 poise at shear rate 100 sec⁻¹ according to capillary rheology measurements known to those skilled in the art, that is, a molecular weight sufficient for fiber forming.

The outstanding balance of properties as above detailed, which is exhibited by the polyester of the invention, had never been achieved before. Hence, another particular aspect of the present invention is directed to a wholly aromatic polyester (hereinafter, “the invented wholly aromatic polyester”) having: a CIELAB ΔE* of 22 or less versus a white reference tile with L*, a* and b* values of 100.01±0.03, −0.04±0.08 and 0.03±0.06, respectively, using D6500 illumination, and

a heat distortion temperature (HDT) of 300° C. or greater measured at 264 psi according to ASTM D648.

The invented wholly aromatic polyester has preferably a CIELAB ΔE* of 20 or less, more preferably of 19 or less, versus a white reference tile with L*, a* and b* values of 100.01±0.03, −0.04±0.08 and 0.03±0.06, respectively, using D6500 illumination.

The invented wholly aromatic polyester has preferably a HDT of at least 305° C., more preferably of at least 310° C., still more preferably of at least 315° C., as measured according to ASTM D648. Its HDT may even be of 320° C. or higher, as shown e.g. in example 3 hereinafter.

The invented wholly aromatic polyester has advantageously a flexural stress at break of at least 10,000 psi, preferably of at least 12,000 psi, more preferably of at least 15,000, still more preferably of at least 18,000, and the most preferably of at least 21,000, as measured according to ASTM D790.

The invented wholly aromatic polyester has advantageously a flexural strain at break of at least 1%, preferably of at least 1.5%, according to ASTM D790 at 0.05″/min, 2″ span and 23° C.

The invented wholly aromatic polyester meets advantageously any of the characteristics of the polyester of the invention as previously detailed, and any of their combinations.

The above written description of the invention provides a manner and process of making and using it such that any person skilled in this art is enabled to make and use the same, this enablement being provided in particular for the subject matter of the appended claims, which make up a part of the original description.

The polyester or a composition comprising the polyester may be used to make one or more component(s) of a LED device, such as a heat sink, a connective material, or a reflector. The polyester, alone or in combination with other materials, may also be used as a matrix material for components such as housings or assembly templates. It is particularly advantageous to use the polyester or the composition comprising the polyester for making a reflector.

The LED device may have a current intensity of at least 1 pA, at least 1 nA, at least 1 μA, at least 1 mA or at least 10 mA; it may have a current intensity of at most 100 A, at most 10000 mA, at most 5000 mA, at most 2000 mA or at most 1000 mA. The LED device is advantageously a low-current LED device (i.e. a LED device characterized by a current intensity of at most 20 mA), a high-current LED device (i.e. a LED device characterized by a current intensity between 20 mA and 75 mA), or a power LED device (i.e. a LED device characterized by a current intensity of at least 75 mA). It is very advantageous to use the polyester or the composition comprising the polyester for making a component, especially a reflector, of either a high-current LED device or a power LED device. The polyester or the composition comprising the polyester is still more advantageously used for making a component, especially a reflector, of a power LED device; said power LED device may be characterized by a current intensity of at least 150 mA, at least 300 mA or at least 500 mA.

The LED device, in particular the power LED device, using a reflector component containing the polyester composition of the invention provides substantially greater light output than conventional LED devices and concurrently provides greater brightness efficiency and a longer lifetime, even when operating at the significantly higher temperatures and power emission levels, as encountered notably in power LED devices.

As used herein, the phrases “selected from the group consisting of,” “chosen from,” and the like include mixtures of the specified materials. Terms such as “contain(s)” and the like as used herein are open terms meaning ‘including at least’ unless otherwise specifically noted. Phrases such as “mention may be made,” etc., preface examples of materials that can be used and do not limit the invention to the specific materials, etc., listed.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

### EXAMPLES

### Experimental Procedures

Color of resin powders packed in a 4×5×1 cm cuvette was measured according to ASTM E 308-06 using a Milton Roy Diano Color Products Scan II with D6500 illumination, CIELAB color scale, observation angle 2° (CIE 1931 standard observer), wavelength range 380 to 700 nm, 10-nm measurement interval. Polymer is ground and sieved by a 20 mesh screen to give a maximum particle size of 850 microns. The color difference for the resin powder compared to white reference tile was calculated using the CIELAB ΔE* (Delta E) equation. The white reference tile (S/N 4DD1202002) values for L*, a* and b* values were 100.01±0.03, −0.04±0.08 and 0.03±0.06, respectively.

Color of compounded resin was obtained from molded disks, 2.5″ diameter and 0.040″ thick according to ASTM E308-06 using a BYK-Gardner Color-Sphere instrument with wavelength range of 400 to 700 nm and interval of 20 nm, no bandpass correction, observation angle of 10° (CIE 1964 supplementary standard observer), D65 illumination and 30 mm and 36 mm measurement and illumination areas, respectively. The color difference for the disks compared to white reference tile was calculated using the CIELAB ΔE* (Delta E) equation. The white reference tile (S/N 870007) values for L*, a* and b* values were 98.86±0.01, −0.17±0.01 and 0.38±0.01, respectively.

The BYK-Gardner Color-Sphere instrument was also used to measure percent reflectance of the disks over the wavelength range of 400 to 700 nm with a 20-nm interval. Reflectance was measured following ASTM E308-06 using diffuse illumination (D65) and 8° observation (d/8) with Specular Component Included, with no bandpass correction and with 30 mm and 36 mm measurement and illumination areas, respectively.

Flexural strain at break and stress at break were measured according to methods:

1. ASTM D790 at 0.05″/MIN, 2″ span and 23° C.
2. ISO 178, 2 mm/min; ISO 790

Tensile strain at break and stress at break were measured according to ISO 527-2, with testing speed 5 mm/min. Tensile modulus (chord modulus, 0.05% to 0.025%) was measured according to ISO-527-2, with testing speed 1 mm/min.

Heat deflection temperature, HDT, is reported in ° C. and was measured according to one of two methods:
1. ASTM D648, at stress level 264 PSI, sample dimensions 5.0″ by 0.5″ by 0.25″; conditioning according to ASTM D-5183.
2. ISO 75, at stress level 1.82 MPa.

Thermal transitions, Tₘ and T_{c}, were measured using TA Instruments Differential Scanning calorimeter Model Q20 or Q1000, or similar instrument. Each sample was evaluated by a first heating ramp followed by an isothermal heating for one minute, a cooling ramp and a second heating ramp. The sample was heated at 20° C./min from room temperature to either 400° C. or 420° C. and held for one minute; then the sample was cooled at 20° C./min to 30° C. and re-heated at 20° C./min to 400° C. or 420° C. Peak crystallization temperature, T_{c}, is determined from the cooling cycle. Peak melting temperature, Tₘ (also designated Tₘ₂), is determined from the second heating ramp.

Viscosity was measured at 380° C. using a Kayeness Galaxy V Rheometer (Model 8052 DM) with LC 9 kN, 2000 lb, melt time 250 sec. Polymer is ground and sieved by a 20 mesh screen to give a maximum particle size of 850 microns. Samples were dried at 150° C. for 15 min prior to testing.

ASTM tensile and flex bars were molded from unfilled resin samples using an 11-Ton Mini-Jector Wasp Model 55. Barrel temperatures ranged from 355° C. to 385° C. and mold temperatures ranged from 175° C. to 190° C.

Compounding of neat resin products synthesized according to the examples below was accomplished as follows: the resin, a rutile titanium dioxide commercially available from DuPont and a chopped fiberglass reinforcement commercially available from PPG were delivered via individual loss in weight feeders, in the weight ratios specified in Table 1 below, to a Coperion ZSK-26 twin screw extruder comprising 12 barrels. The polyester and TiO₂ were delivered to barrel 1 whereupon the mixture was melted and dispersed before barrel 7. Optionally, anti-oxidants and heat stabilizers were similarly delivered at barrel 1. A side stuffer introduced fiberglass at barrel 7.

The fiberglass was distributed throughout the melted mixture in barrels 8 and 9 of the extruder. The new mixture was degassed via vacuum in barrel 10 of the extruder. That new mixture was compressed and cooled in barrels 11 and 12.

The thermal profile of the extruder was: no heat in barrel 1/360° C. in barrels 2 to 5/350° C. in barrels 6&7/330° C. in barrel 8/320° C. in barrel 9/310° C. in barrels 10 and 11 and 300° C. in barrel 12. The screw rate was 350 rpm. The extrudate from barrel 12 was cooled and pelletized with conventional equipment. Compound compositions according to the invention are described in Table 6 below.

TABLE 1
Compounding Parameters

| | Example |
|---|---|
| In barrel 1: | |
| polyester | 54 |
| Rutile titanium dioxide | 24 |
| Antioxidant/heat stabilizer | 1 |
| In barrel 5 (delayed addition): | |
| fiberglass | 21 |

Compounds were molded using a Toyo 55T injection molding machine with heater zones set to 640° F. (at nozzle), 630° F., 620° F. and 605° F. (at feed). Product color disks and ISO tensile bars were tested as described above.

### Resin Synthesis

TABLE 2
Designations for Monomers and Structural Units

| Monomer | Designation | Structural Unit |
|---|---|---|
| p-hydroxybenzoic acid | A | V |
| terephthalic acid | B | III |
| isophthalic acid | C | IV |
| hydroquinone | D | I |
| 4,4′-biphenol | E | II |

In addition to the monomers, acylating reagents and catalysts known to those skilled in the art are employed in the synthesis of the resins of the invention.

### Example 1

The monomers in the amounts 505.9 g A, 270.6 g B, 5.8 g C, 85.4 g, D and 165.3 g E and catalyst were charged into a 2-liter reactor vessel equipped with an electrical heating mantle, overhead mechanical stirrer, reflux condenser, stopcock adapter and distillate receiver. The reactor was purged with nitrogen and then acetic anhydride was added. The mixture was constantly stirred and heated to a temperature of 145° C. and held under reflux for an additional hour. The distillation of acetic acid from the reaction was begun while the external temperature was increased at the rate of 0.5° C./min to 280° C. Then the heating rate was stepped to 0.75° C./min to 310° C. to form a pre-polymer. When the reaction reached 310° C. the heating mantle was turned off and removed for faster cooling. After the reactor cooled to ambient temperature, the pre-polymer was removed and ground to a particle size of about 1-2 mm. Solid state polymerization was carried out on the pre-polymer product by raising the temperature from room temperature to 310° C. over 12 hours and then maintaining temperature at 310° C. under continuous nitrogen flow for 3.75 hrs.

Differential scanning calorimetery (DSC) measurements for this polyester example indicated a temperature of crystallization, T_{c} of 329° C. and a melt temperature, Tₘ of 370° C. The viscosity at 380° C. with a shear rate of 100 sec⁻¹ was 890 poise.

### Example 2

This example followed the same procedure as Example 1. The ingredient amounts for Example 2 were the following: p-hydroxybenzoic acid (pHBA) 642.1 g, terephthalic acid (TA) 197.2 g, isophthalic acid (IA) 10.9 g, hydroquinone (HQ) 68.5 g, 4,4′-biphenol (BP) 117.2 g. The solid state polymerization was carried out for 13 minutes at 310° C. The DSC analysis gave temperature of crystallization of T_{c}=338° C. and the melt temperature Tₘ=382° C. The melt viscosity at 380° C. and shear rate of 100 sec⁻¹ was 1551 poise.

### Example 3

This example followed the same procedure as Example 1. The ingredient amounts for Example 3 were the following: p-hydroxybenzoic acid (pHBA) 568.3 g, terephthalic acid (TA) 227.8 g, hydroquinone (HQ) 30.2 g, 4,4′-biphenol (BP) 204.3 g.

The solid state advancing was carried out for 4.5 hrs at 310° C. The DSC analysis gave temperature of crystallization of T_{c}=335° C. and the melt temperature of Tₘ=372° C. The melt viscosity at 380° C. with shear rate of 100 sec⁻¹ was 690 poise.

### Example 4

This example followed the same procedure as Example 1. The ingredient amounts for Example 4 were the following: p-hydroxybenzoic acid (pHBA) 568.3 g, terephthalic acid (TA) 218.7 g, isophthalic acid (IA) 9.1 g, hydroquinone (HQ) 30.2 g, 4,4′-biphenol (BP) 204.3 g.

The solid state advancing was carried out for 4.5 hrs at 310° C. The DSC analysis gave temperature of crystallization of Tc=330° C. and Tm=368° C. The melt viscosity at 380° C. with shear rate of 100 sec⁻¹ was 600 poise.

### Example 5

This example followed the same procedure as Example 1. The ingredient amounts for Example 5 were the following: p-hydroxybenzoic acid (pHBA) 535.1 g, terephthalic acid (TA) 256.2 g, isophthalic acid (IA) 7.1 g, hydroquinone (HQ) 86.1 g, 4,4′-biphenol (BP) 149.5 g.

The solid state advancing was carried out for 2.75 hrs at 310° C. The DSC analysis gave temperature of crystallization of Tc=333° C. and Tm=367° C. The melt viscosity at 380° C. with shear rate of 100 sec⁻¹ was 1200 poise.

### Comparative Example 1

The following formulation is a comparative example of the new polyester synthesis based on four monomers: p-hydroxybenzoic acid (pHBA), terephthalic acid (TA), isophthalic acid (IA). Hydroquinone (HQ), and 4,4′-biphenol (BP). After the temperature reached 280° C., heating was carried out at a rate of 2.0° C./min. Also lower excess of acetic anhydride was used. The ingredient amounts for CE1 were the following: p-hydroxybenzoic acid (pHBA) 541.2 g, terephthalic acid (TA) 248.6 g, isophthalic acid (IA) 17.8 g, hydroquinone (HQ) 117.7 g, 4,4′-biphenol (BP) 112.8 g.

The solid state advancing was carried out for 23 minutes at 310° C. The DSC analysis gave temperature of crystallization of T_{c}=338° C. and Tₘ=387° C. The melt viscosity at 380° C. and the shear rate of 100 sec⁻¹ was 1900 poise.

### Comparative Example 2

This comparative example followed the same procedure as Comparative Example 1 but a temperature rate of 0.5° C./min was maintained until the end of the synthesis. Also the excess of acetic anhydride doubled and the amounts of catalysts were reduced. The ingredient amounts for CE2 were the following: p-hydroxybenzoic acid (pHBA) 555.5 g, terephthalic acid (TA) 167 g, isophthalic acid (IA) 55.7 g, no hydroquinone (HQ) used, 4,4′-biphenol (BP) 249.6 g.

The solid state advancing was carried out for 30 minutes at 310° C. The DSC analysis gave temperature of crystallization of T_{c}=310° C. and the melt temperature of Tₘ=361° C. The melt viscosity at 370° C. and the shear rate of 100 sec⁻¹ was 1800 poise.

Table 3 summarizes the relative ratios of monomer units introduced into the acylation vessel for Examples 1 through 5 and Comparative Examples 1 and 2.

TABLE 3
Composition of Polyester Resins, Molar Content of Structural Units

| | mol % | | | I, | | | |
|---|---|---|---|---|---|---|---|
| | V, | I/II, | IV/III, | mol % | mol % II, | mol % IV, | mol % III, |
| Example | pHBA | HQ/BP | I/T | HQ | BP | IPA | TPA |
| example 1 | 52.4% | 0.87 | 0.021 | 11.1% | 12.7% | 0.5% | 23.3% |
| example 2 | 65.0% | 0.99 | 0.055 | 8.7% | 8.8% | 0.9% | 16.6% |
| example 3 | 60.0% | 0.25 | 0.000 | 4.0% | 16.0% | 0.0% | 20.0% |
| example 4 | 60.0% | 0.25 | 0.040 | 4.0% | 16.0% | 0.8% | 19.2% |
| example 5 | 55.0% | 0.99 | 0.028 | 11.1% | 11.5% | 0.6% | 21.9% |
| comparative | 55.0% | 1.76 | 0.071 | 15.0% | 8.5% | 1.5% | 21.0% |
| example 1 | | | | | | | |
| comparative | 60.0% | 0 | 0.333 | 0.0% | 20.0% | 5.0% | 15.0% |
| example 2 | | | | | | | |

The melting temperature (Tₘ) and the crystallization temperatures (T_{c}) for the resins formed in the examples are shown in Table 4.

TABLE 4
Melting Point and Crystallization Point of Polyester Resins

| Example | Tₘ, ° C. | T_{c}, ° C. |
|---|---|---|
| example 1 | 370 | 329 |
| example 2 | 382 | 338 |
| example 3 | 372 | 335 |
| example 4 | 368 | 330 |
| example 5 | 367 | 333 |
| comparative | 387 | 338 |
| example 1 | | |
| comparative | 361 | 310 |
| example 2 | | |

Physical and color properties are summarized in Table 5.

TABLE 5
Physical Properties, Test Bars Molded from Neat Polyester Resins

| | | | | Heat |
|---|---|---|---|---|
| | Resin | ASTM, Flex | ASTM, flex | Deflection |
| | Powder, | strain at | stress at | Temperature, |
| Example | CIELAB ΔE* | break | break, psi | ° C. |
| example 1 | 20 | 3.7% | 21300 | 315 |
| example 2 | 19 | 2.0% | 15600 | 315 |
| example 3 | 22 | 3.3% | 18800 | 310 |
| example 4 | 21 | 3.8% | 21900 | 323 |
| example 5 | 20 | 3.7% | 18700 | 306 |
| comparative | 18 | 2.0% | 8160 | 276 |
| example 1 | | | | |
| comparative | 24 | 3.8% | 19300 | 249 |
| example 2 | | | | |

Samples of the polyester of the invention were compounded with reinforcing fillers and pigments such as TiO₂. Compositions of compounded resins and compounds are shown in Table 6.

TABLE 6
Composition, Compounds of Polyester Resins

| | | | | | Pigment |
|---|---|---|---|---|---|
| | Resin, Monomer | | | Glass | (rutile |
| | Molar ratios: | Tₘ, | Resin* | Fibers, | TiO₂), |
| Compound | A/B/C/D/E | ° C. | wt % | wt % | wt % |
| Example I-A | 60/19.2/0.8/ | 363 | 55% | 21% | 24% |
| | 7.5/12.5 | | | | |
| Comparative | 60/15/5/0/20 | 349 | 55% | 21% | 24% |
| Ex II-A | | | | | |
| Comparative | 55/21/1.5/ | 372 | 55% | 21% | 24% |
| Ex II-B | 15/8.5 | | | | |

*Including 1% of antioxidant/heat stabilizer

### Synthesis of the Polyester Resin Included in the Compound of Example I-A

This example followed the same procedure as Example 1. The relative monomer amounts for the polyester resin included in the compound of example I-A were the following: p-hydroxybenzoic acid (pHBA) 60 mole %, terephthalic acid (TA) 19.2 mole %, isophthalic acid (IA) 0.8 mole %, hydroquinone (HQ) 7.5 mole % and 4,4′-biphenol (BP) 12.5 mole %.

The solid state advancing was carried out for a total of 14.5 hours with a stepwise heating profile under a nitrogen blanket, starting from 24° C. and ending with the last three hours at 310° C. The DSC analysis gave temperature of crystallization of T_{c}=337° C. and Tₘ=367° C. The melt viscosity of the polyester resin included in the compound of example I-A at 380° C. with shear rate of 100 sec⁻¹ was 1100 poise. Its color, measured on the powder by CIELAB ΔE* parameter, was 20. Its ASTM flex stress was 20800 MPa, and its ASTM Flex strain was 4.7%. Its HDT was 320° C. @264 psi (ASTM D648).

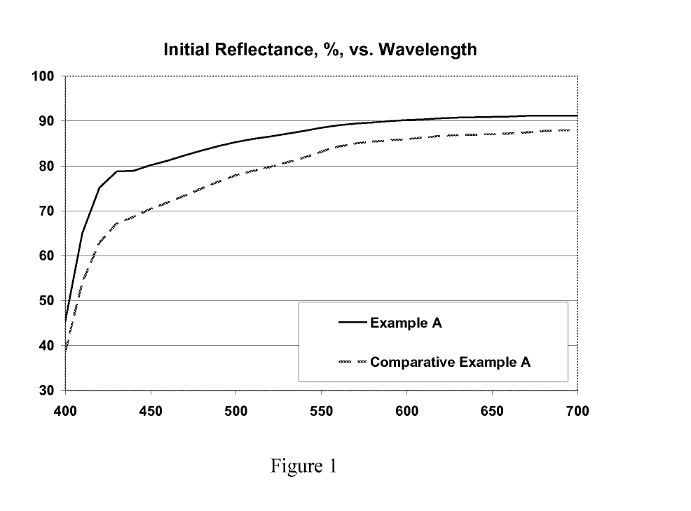

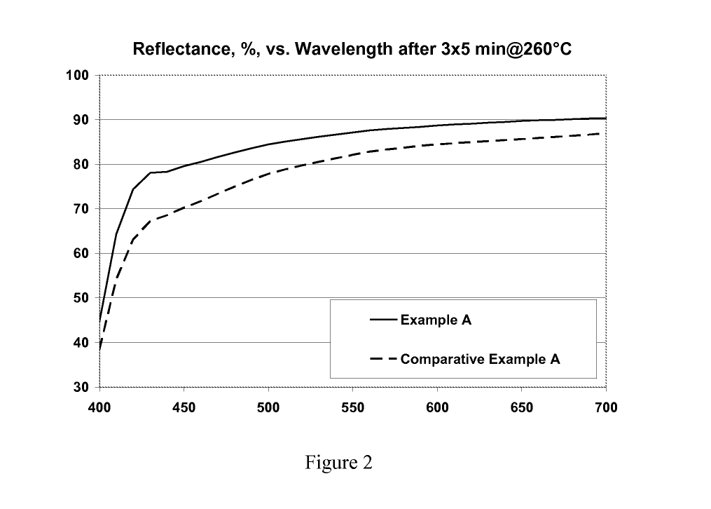

Physical properties (Table 7) and color properties (Table 8) of compounded examples are shown below. Reflectance measurements for compounded samples I-A and II-A are also shown in FIG. 1 and FIG. 2.

TABLE 7
Physical Properties, Test Bars Molded from Compounds

| | | ISO | | ISO | | |
|---|---|---|---|---|---|---|
| | | Tensile | ISO | Tensile | | ISO flex |
| | | Chord | Tensile | Stress @ | | Stress @ |
| | ISO | Modulus, | Strain @ | Break, | ISO flex | Break, |
| | HDT, ° C. | Mpa | Break, % | MPa | @ Break, % | MPa |
| Example I-A | 293 | 10200 | 0.74 | 59 | 1.6 | 103 |
| Comparative | 263 | 12600 | 0.99 | 88 | 1.6 | 137 |
| Ex II-A | | | | | | |
| Comparative | 285 | 10400 | 0.37 | 40 | 0.68 | 64.8 |
| Ex II-B | | | | | | |

TABLE 8
Reflectance and Color Properties of Molded Compounds

| | | | % Reflectance | | % Reflectance | |
|---|---|---|---|---|---|---|
| | CIELAB ΔE* | | at 460 nm | | at 560 nm | |
| | As | Aged 160° C., | As | Aged 160° C., | As | Aged 160° C., |
| | molded | 8 h | molded | 8 h | molded | 8 h |
| Example I-A | 7.4 | 7.03 | 81.1 | 81.6 | 89.0 | 88.5 |
| Comparative | 11.9 | 11.7 | 71.8 | 72.0 | 84.3 | 84.2 |
| Ex II-A | | | | | | |
| Comparative | 8.10 | 8.95 | 79.6 | 77.7 | 88.0 | 86.9 |
| Ex II-B | | | | | | |

### Additional Examples

Samples of the polyester of the invention are further compounded with rutile TiO₂ pigment, and optionally in addition with various optical brighteners, as detailed below:
BLANKOPHOR® BBH optical brightener, commercially available from BAYER, which includes disodium 4,4′-bis{(4-anilino-6-morpholino-1,3,5-triazin-2-yl)amino}stilbene-2,2′-disulfonate;
CBS-127 optical brightener, commercially available from Jinan Subang Chemical Co. Ltd., which includes 4,4′-bis[2-(2-methoxyphenyl)ethenyl]1,1′-biphenyl
CBS-X optical brightener, commercially available from Jinan Subang Chemical Co. Ltd., which includes 4.4′-bis(2-disulfonic acid styryl) 1,1′-biphenyl
EASTOBRITE® OB-1 optical brightener, commercially available from EASTMAN Chemicals, which includes 2,2′-(2,5-thiophenediyl)bis(5-(1,1-dimethylethyl)-benzoxazole
EASTOBRITE® OB-3 optical brightener, commercially available from EASTMAN Chemicals, which is thought to include one or more benzoxazole derivatives
HOSTALUX® KCB optical brightener, commercially available from CLARIANT, which includes 2,2′-(1,4-naphthalenediyl)bisbenzoxazole
HOSTALUX® KSB optical brightener, commercially available from CLARIANT, which is thought to include one or more benzoxazole derivatives
HOSTALUX® KSN optical brightener, commercially available from CLARIANT, which is thought to include one or more bisbenzoxazolylstilbene derivatives
LEUKOPUR® EGM optical brightener, commercially available from SANDOZ, which includes 7-(2H-naphtho[1,2-d]triazol-2-yl)-3-phenylcoumarin
PHORWITE® K-20G2, commercially available from MOBAY Chemical Corporation, which is thought to include one or more pyrazoline derivatives

Compositions of compounds are shown in Tables 9 to 11.

TABLE 9
Compositions of compounds based on the polyester of example 2

| | Compound Nb. | | | | | | | | | | |
|---|---|---|---|---|---|---|---|---|---|---|---|
| | III | IV | V | VI | VII | VIII | IX | X | XI | XII | XIII |
| | wt % | wt % | wt % | wt % | wt % | wt % | wt % | wt % | wt % | wt % | wt % |
| Polyester of ex. 2 | 60 | 59.97 | 59.97 | 59.97 | 59.97 | 59.97 | 59.97 | 59.97 | 59.97 | 59.97 | 59.97 |
| Rutile titanium dioxide | 40 | 40 | 40 | 40 | 40 | 40 | 40 | 40 | 40 | 40 | 40 |
| BLANKOPHOR ® | 0 | 0.03 | 0 | 0 | 0 | 0 | 0 | 0 | 0 | 0 | 0 |
| BBH | | | | | | | | | | | |
| CBS-127 | 0 | 0 | 0.03 | 0 | 0 | 0 | 0 | 0 | 0 | 0 | 0 |
| CBS-X | 0 | 0 | 0 | 0.03 | 0 | 0 | 0 | 0 | 0 | 0 | 0 |
| EASTOBRITE ® OB-1 | 0 | 0 | 0 | 0 | 0.03 | 0 | 0 | 0 | 0 | 0 | 0 |
| EASTOBRITE ® OB-3 | 0 | 0 | 0 | 0 | 0 | 0.03 | 0 | 0 | 0 | 0 | 0 |
| HOSTALUX ® KCB | 0 | 0 | 0 | 0 | 0 | 0 | 0.03 | 0 | 0 | 0 | 0 |
| HOSTALUX ® KSB | 0 | 0 | 0 | 0 | 0 | 0 | 0 | 0.03 | 0 | 0 | 0 |
| HOSTALUX ® KSN | 0 | 0 | 0 | 0 | 0 | 0 | 0 | 0 | 0.03 | 0 | 0 |
| LEUKOPUR ® EGM | 0 | 0 | 0 | 0 | 0 | 0 | 0 | 0 | 0 | 0.03 | 0 |
| PHORWITE ® K-20G2 | 0 | 0 | 0 | 0 | 0 | 0 | 0 | 0 | 0 | 0 | 0.03 |

TABLE 10
Compositions of compounds based on the polyester of example 4

| | Compound Nb. | | | | | | | | | | |
|---|---|---|---|---|---|---|---|---|---|---|---|
| | XIV | XV | XVI | XVII | XVIII | XIX | XX | XXI | XXII | XXIII | XXIV |
| | wt % | wt % | wt % | wt % | wt % | wt % | wt % | wt % | wt % | wt % | wt % |
| Polyester of ex. 4 | 60 | 59.97 | 59.97 | 59.97 | 59.97 | 59.97 | 59.97 | 59.97 | 59.97 | 59.97 | 59.97 |
| Rutile titanium dioxide | 40 | 40 | 40 | 40 | 40 | 40 | 40 | 40 | 40 | 40 | 40 |
| BLANKOPHOR ® | 0 | 0.03 | 0 | 0 | 0 | 0 | 0 | 0 | 0 | 0 | 0 |
| BBH | | | | | | | | | | | |
| CBS-127 | 0 | 0 | 0.03 | 0 | 0 | 0 | 0 | 0 | 0 | 0 | 0 |
| CBS-X | 0 | 0 | 0 | 0.03 | 0 | 0 | 0 | 0 | 0 | 0 | 0 |
| EASTOBRITE ® OB-1 | 0 | 0 | 0 | 0 | 0.03 | 0 | 0 | 0 | 0 | 0 | 0 |
| EASTOBRITE ® OB-3 | 0 | 0 | 0 | 0 | 0 | 0.03 | 0 | 0 | 0 | 0 | 0 |
| HOSTALUX ® KCB | 0 | 0 | 0 | 0 | 0 | 0 | 0.03 | 0 | 0 | 0 | 0 |
| HOSTALUX ® KSB | 0 | 0 | 0 | 0 | 0 | 0 | 0 | 0.03 | 0 | 0 | 0 |
| HOSTALUX ® KSN | 0 | 0 | 0 | 0 | 0 | 0 | 0 | 0 | 0.03 | 0 | 0 |
| LEUKOPUR ® EGM | 0 | 0 | 0 | 0 | 0 | 0 | 0 | 0 | 0 | 0.03 | 0 |
| PHORWITE ® K-20G2 | 0 | 0 | 0 | 0 | 0 | 0 | 0 | 0 | 0 | 0 | 0.03 |

TABLE 11
Compositions of compounds based on the polyester of example 6

| | Compound Nb. | | | | | | | | | | |
|---|---|---|---|---|---|---|---|---|---|---|---|
| | XXV | XXVI | XXVII | XXVIII | XXIX | XXX | XXXI | XXXII | XXXIII | XXXIV | XXXV |
| | wt % | wt % | wt % | wt % | wt % | wt % | wt % | wt % | wt % | wt % | wt % |
| Polyester of ex. 6 | 60 | 59.97 | 59.97 | 59.97 | 59.97 | 59.97 | 59.97 | 59.97 | 59.97 | 59.97 | 59.97 |
| Rutile titanium dioxide | 40 | 40 | 40 | 40 | 40 | 40 | 40 | 40 | 40 | 40 | 40 |
| BLANKOPHOR ® | 0 | 0.03 | 0 | 0 | 0 | 0 | 0 | 0 | 0 | 0 | 0 |
| BBH | | | | | | | | | | | |
| CBS-127 | 0 | 0 | 0.03 | 0 | 0 | 0 | 0 | 0 | 0 | 0 | 0 |
| CBS-X | 0 | 0 | 0 | 0.03 | 0 | 0 | 0 | 0 | 0 | 0 | 0 |
| EASTOBRITE ® OB-1 | 0 | 0 | 0 | 0 | 0.03 | 0 | 0 | 0 | 0 | 0 | 0 |
| EASTOBRITE ® OB-3 | 0 | 0 | 0 | 0 | 0 | 0.03 | 0 | 0 | 0 | 0 | 0 |
| HOSTALUX ® KCB | 0 | 0 | 0 | 0 | 0 | 0 | 0.03 | 0 | 0 | 0 | 0 |
| HOSTALUX ® KSB | 0 | 0 | 0 | 0 | 0 | 0 | 0 | 0.03 | 0 | 0 | 0 |
| HOSTALUX ® KSN | 0 | 0 | 0 | 0 | 0 | 0 | 0 | 0 | 0.03 | 0 | 0 |
| LEUKOPUR ® EGM | 0 | 0 | 0 | 0 | 0 | 0 | 0 | 0 | 0 | 0.03 | 0 |
| PHORWITE ® K-20G2 | 0 | 0 | 0 | 0 | 0 | 0 | 0 | 0 | 0 | 0 | 0.03 |

Compounding of neat polyesters synthesized according to examples 2, 4 and 6 is accomplished as follows: the polyester resin, a rutile titanium dioxide commercially available from DuPont, and optionally in addition an optical brightener, are delivered via individual loss in weight feeders, in the weight ratios specified in above Tables 9, 10 and 11, to a Coperion ZSK-40 co-rotating intermeshing twin screw 40 mm extruder with 12 barrel sections, giving an L/D ratio of 48. The polyester and, when present the optical brightener, are delivered to barrel 1, while the rutile titanium dioxide is delivered at barrel 2. The mixture is degassed via vacuum in barrel 10 of the extruder. It is compressed and cooled in barrels 11 and 12.

The thermal profile of the extruder is: 150° C. in barrel 1/360° C. in barrels 2 to 5/350° C. in barrels 6/340° C. in barrel 7/330° C. in barrel 8/320° C. in barrel 9/310° C. in barrel 10/300° C. in barrels 11 and 12. The screw rate is 300 rpm.

The extrudate from barrel 12 is cooled and pelletized with conventional equipment.

1. A polyester, comprising:
structural units (I) derived from hydroquinone, 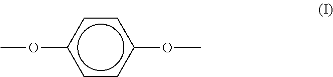
structural units (II) derived from 4,4′-biphenol, 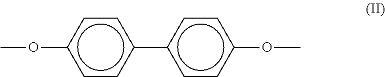
structural units (III) derived from terephthalic acid, 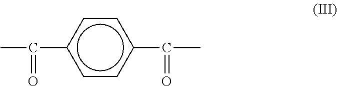
and structural units (V) derived from p-hydroxybenzoic acid, 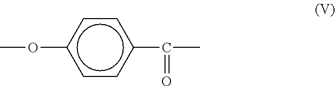
and, optionally in addition, structural units (IV) derived from isophthalic acid; 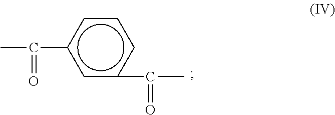
wherein the structural units derived from p-hydroxybenzoic acid are present in an amount of 40-80 mole %, the structural units derived from terephthalic and isophthalic acid are present in a total amount of 10-30 mole %, and the structural units derived from hydroquinone and 4,4′-biphenol are present in a total amount of 10-30 mole %, wherein mole % is based on the total number of moles of structural units (I), (II), (III), (IV) and (V) present in the polyester;
wherein the molar ratio of the structural units derived from hydroquinone to the structural units derived from 4,4′-biphenol is from 0.1 to 1.5;
wherein the molar ratio of the structural units derived from isophthalic acid to the structural units derived from terephthalic acid is from 0 to 0.1; and
wherein at least 80 mole % of all of the structural units of the polyester are selected from the group consisting of structural units (I), (II), (III), (IV) and (V).

2. The polyester according to claim 1, wherein the molar ratio of the structural units (hydroquinone+4,4′-biphenol)/(terephthalic acid+isophthalic acid) is from 0.95 to 1.05, and the total number of moles of the structural units (I), (II), (III), (IV) and (V) is of at least 95 mole % based on the total number of moles of all structural units, and the molar ratio of the structural units derived from isophthalic acid to the structural units derived from terephthalic acid is from 0.02 to 0.5.

3. (canceled)

4. The polyester according to claim 1, being selected from the group consisting of:
polyesters comprising 1.5 to 15 mole % of structural units derived from hydroquinone (I); 8 to 23 mole % of structural units derived from 4,4′-biphenol (II); 18 to 25 mole % of structural units derived from terephthalic acid (III); 0 to 2.5 mole % of structural units derived from isophthalic acid (IV); and 50-65 mole % of structural units derived from p-hydroxybenzoic acid (V), and
polyesters comprising 0.8 to 13.5 mole % of structural units derived from hydroquinone (I); 4 to 20.5 mole % of structural units derived from 4,4′-biphenol (II); 9 to 22.5 mole % of structural units derived from terephthalic acid (III); 0 to 2 mole % of structural units derived from isophthalic acid (IV); and 55-60 mole % of structural units derived from p-hydroxybenzoic acid (V),
wherein mole % is based on the total number of moles of structural units (I), (II), (III), (IV) and (V) present in the polyester.

5. The polyester according to claim 1, being a wholly aromatic polyester.

6. The polyester according to claim 1, having:
a CIELAB ΔE* of 22 or less versus a white reference tile with L*, a* and b* values of 100.01±0.03, −0.04±0.08 and 0.03±0.06, respectively, using D6500 illumination, and
a heat distortion temperature (HDT) of 300° C. or greater measured at 264 psi according to ASTM D648.

7. A wholly aromatic polyester having:
a CIELAB ΔE* of 22 or less versus a white reference tile with L*, a* and b* values of 100.01±0.03, −0.04±0.08 and 0.03±0.06, respectively, using D6500 illumination, and
a heat distortion temperature (HDT) of 300° C. or greater measured at 264 psi according to ASTM D648.

8. (canceled)

9. A process for manufacturing a polyester, comprising:
forming an initial monomer mixture comprising 40-80 mole % of p-hydroxybenzoic acid, 10 to 30 mole % of a diol mixture consisting of hydroquinone and 4,4′-biphenol, and 10 to 30 mole % of diacid consisting of terephthalic acid and, optionally in addition, isophthalic acid, wherein mole % is based on the total number of moles of p-hydroxybenzoic acid, hydroquinone, 4,4′-biphenol, terephthalic acid and isophthalic acid present in the initial monomer mixture;
wherein the molar ratio of hydroquinone to 4,4′-biphenol is from 0.1 to 1.5;
wherein the molar ratio of isophthalic acid to terephthalic acid is from 0 to 0.1; and
wherein at least 80 mole % of all of the monomers of the initial monomer mixture are selected from the group consisting of p-hydroxybenzoic acid, hydroquinone, 4,4′-biphenol, terephthalic acid and isophthalic acid;
reacting the monomers of the initial monomer mixture to form the polyester.

10. The process according to claim 9, further comprising:
mixing the initial monomer mixture with an acylating agent to form an acylation mixture;
wherein the reacting comprises:
heating the acylation mixture to a first temperature to form an acylated monomer mixture; and
heating the acylated monomer mixture to a second temperature to carry out solid state polycondensation of the acylated monomer mixture.

11. The process according to claim 9, wherein the polyester is the polyester according to claim 1.

12. A composition comprising the polyester according to claim 1.

13. The composition according to claim 12, further comprising at least one optical brightener.

14. A shaped article comprising the polyester according to claim 1.

15. A light emitting diode (LED) device comprising a component which is the shaped article according to claim 14.

16. The LED device according to claim 15, wherein the component is a LED reflector.

17. The LED device according to claim 15, which is as a high-current LED device or a power LED device.
